(19) United States
(12) Patent Application Publication
(10) Pub. No.: US 2014/0228483 A1
(43) Pub. Date: Aug. 14, 2014

(54) COMPOSITIONS USEFUL FOR PREPARING COMPOSITES AND COMPOSITES PRODUCED THEREWITH

(71) Applicant: MOMENTIVE SPECIALTY CHEMICALS INC., Columbus, OH (US)

(72) Inventor: Charles David Shirrell, Katy, TX (US)

(73) Assignee: Momentive Specialty Chemicals Inc., Columbus, OH (US)

(21) Appl. No.: 13/766,474

(22) Filed: Feb. 13, 2013

(51) Int. Cl. C08L 63/04; C08L 9/00; C08L 71/08

(52) U.S. Cl. CPC C08L 63/04; C08L 71/08; C08L 9/00
USPC 523/400; 525/109

(57) ABSTRACT

A thermosettable epoxy resin composition having, as components: (1) an epoxy resin; (2) an epoxidized cycloaliphatic dicyclopentadiene phenolic resin; (3) a liquid oligomeric butadiene homopolymer; and (4) a curing agent including one or more alkylphenol novolac resins or alkyphenol co-novolac resins, and one or more poly(2,6-dimethyl-1,4-phenylene oxides), which resin composition may be used to prepare composites, prepregs, or laminates.

### FIELD OF THE INVENTION

The invention relates to epoxy compositions. The invention particularly relates to compositions useful in the manufacture of composites, and especially prepregs, used in the preparation of composite structures, such as laminates.

### BACKGROUND OF THE INVENTION

Laminates are generally manufactured by pressing, under elevated temperatures and pressures, various layers of partially cured “prepregs”. These prepregs are generally manufactured by impregnating a thermosettable epoxy resin composition into a porous substrate, such as a glass fiber mat, followed by processing at elevated temperatures to promote a partial cure of the epoxy resin in the mat to a “B-stage.” Complete cure of the epoxy resin impregnated in the glass fiber mat typically occurs during the lamination step when the prepreg layers are again pressed under elevated temperatures for a sufficient time.

Epoxy resin systems having a high Glass Transition Temperature (T_{g}) are often desirable in the manufacture of prepregs and the laminates prepared therewith. Such systems may offer, for example, improved heat resistance and reduced thermal expansion. These properties along with low Dielectric Constant (Dₖ), and Dissipation (D_{f}) at frequencies above 1.0 GHz may be required for applications such as complex printed circuit board circuitry and for higher fabrication and usage temperatures.

### SUMMARY OF THE INVENTION

In one aspect, the invention is a thermosettable epoxy resin composition having, as components: (1) an epoxy resin; (2) an epoxidized cycloaliphatic dicyclopentadiene phenolic resin; (3) a liquid oligomeric butadiene homopolymer; and (4) a curing agent including one or more alkylphenol novolac resins or alkyphenol co-novolac resins, and one or more poly(2,6-dimethyl-1,4-phenylene oxides).

In another aspect the invention is a composite, a prepreg, or a laminate including a prepreg, prepared using a thermosettable epoxy resin composition having, as formulation components: (1) an epoxy resin; (2) an epoxidized cycloaliphatic dicyclopentadiene phenolic resin; (3) a liquid oligomeric butadiene homopolymer; and (4) a curing agent including one or more alkylphenol novolac resins or alkyphenol co-novolac resins, and one or more poly(2,6-dimethyl-1,4-phenylene oxides).

### BRIEF DESCRIPTION OF THE DRAWINGS

FIG. 1 is a plot of the Dielectric Constant as a function of Frequency for Example 11 of the invention and Comparative Examples 1, 2, 3 and 7.

FIG. 2 is a plot of the Dissipation as a function of Frequency for Example 11 of the invention and Comparative Examples 1, 2, 3 and 7.

FIG. 3 is a plot of the Dielectric Constant as a function of Frequency for Example 14 of the invention and Comparative Examples 1, 2, 3 and 9.

FIG. 4 is a plot of the Dissipation as a function of Frequency for Example 14 of the invention and Comparative Examples 1, 2, 3 and 9.

FIG. 5 is a photograph of the surface of a prepreg made using Comparative Example 5.

FIG. 6 is a photograph of the surface of a prepreg made using Comparative Example 6.

FIG. 7 is a photograph of the surface of a prepreg made using Comparative Example 7.

FIG. 8 is a photograph of the surface of a prepreg made using Comparative Example 8.

FIG. 9 is a photograph of the surface of a prepreg made using Comparative Example 9.

FIG. 10 is a photograph of the surface of a prepreg made using Comparative Example 10.

FIG. 11 is a photograph of the surface of a prepreg made using Example 11.

FIG. 12 is a photograph of the surface of a prepreg made using Example 12.

FIG. 13 is a photograph of the surface of a prepreg made using Example 13.

FIG. 14 is a photograph of the surface of a prepreg made using Example 14.

FIG. 15 is a photograph of the surface of a prepreg made using Example 15.

FIG. 16 is a photograph of the surface of a prepreg made using Example 16.

### DETAILED DESCRIPTION OF THE INVENTION

In the practice of at least one embodiment of the invention, a laminate is prepared using a thermosettable epoxy resin composition having, as components, (1) an epoxy resin; (2) an epoxidized cycloaliphatic dicyclopentadiene phenolic resin; (3) a liquid oligomeric butadiene homopolymer; and (4) a curing agent including one or more alkylphenol novolac resins or alkyphenol co-novolac resins, and one or more poly(2,6-dimethyl-1,4-phenylene oxides).

### Epoxy Resin Component

Epoxy resins are those resins containing at least one vicinal epoxy group. The epoxy resins useful as components of the thermosettable epoxy resin composition of the disclosure may be saturated or unsaturated, aliphatic, cycloaliphatic, aromatic or heterocyclic, and may be substituted with alkyl and other moieties. The epoxy resin component may also be monomeric or polymeric.

The epoxy resin component utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

In one embodiment, the epoxy resins utilized in the compositions of the application include those resins produced from an epihalohydrin and a phenol or a phenol type compound. The phenol type compounds include compounds having an average of more than one aromatic hydroxyl group per molecule. Examples of phenol type compounds include, but are not limited to dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (i.e. the reaction product of phenols and simple aldehydes, preferably formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins or combinations thereof.

In another embodiment, the epoxy resin components utilized in the compositions of the disclosure may desirably include those resins produced from an epihalohydrin and bisphenols, halogenated bisphenols, hydrogenated bisphenols, novolac resins, and polyalkylene glycols or combinations thereof.

In still another embodiment, the epoxy resin components utilized in the thermosettable epoxy resin compositions of the disclosure may include those resins produced from an epihalohydrin and resorcinol, catechol, hydroquinone, biphenol, bisphenol-A, bisphenol-AP (1,1-bis(4-hydroxyphenyl)-1-phenyl ethane), bisphenol F, bisphenol K, tetrabromobisphenol-A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol-A, or combinations thereof.

In an embodiment that may have fire retardant properties, the epoxy resin component may include a halogenated epoxy resin, an in-situ halogenated epoxy resin or a combination thereof. In some embodiments, the halogen is desirably bromine. In-situ bromination may be performed, for example, utilizing in combination an epoxy resin and a brominated phenol, such as, for example, tetrabrominated bisphenol-A (TBBPA). The amount of bromine in the system may be adjusted such that the total burn time of a laminate produced, as measured by Underwriter Laboratories test UL94, is between about 2 to about 50 seconds. In some embodiments, the total burn time is from about 10 to about 50 seconds and in other embodiments, from about 15 to about 30 seconds. All individual UL94 test specimen burn times were less than 10 seconds. The epoxy resin component may include a resin prepared from an epihalohydrin and a phenol or a phenol type compound utilized in combination with a brominated epoxy resins or an in-situ brominated epoxy resin.

In another embodiment, the epoxy resin component includes a mixture of an epoxy resin and a flame retarded additive and phenolic hydroxyl groups. The flame retardant additive may or may not contain a halogen. Suitable examples of halogenated flame retardant additives include, but are not limited to, tetrabromobisphenol-A (TBBPA), epoxidized TBBPA and its oligomers (EPON™ Resin 1163), tetrachlorobisphenol-A (TCBPA), epoxidized TCBPA and its oligomers, brominated and chlorinated novolacs, bromophenol & chlorophenol, dibromophenol & dichlorophenol, 2,4,6-Tribromophenol and 2,4,6-Trichlorophenol, halogenated β-lactones, chlorendic anhydride[1,4,5,6,7,7-hexachlorobicyclo[2.2.1]-5-heptane-2,3-dicarboxylic acid], chlorinated waxes, tetrabromophthalic anhydride, oligomeric brominated polycarbonates and combinations thereof.

Suitable examples of non-halogenated flame retardant additives include, but are not limited to aluminum oxide hydrates, aluminum carbonates, magnesium hydroxides, vitrifying borates and phosphates, red phosphorous, phosphoric acid esters, phosphonic acid esters, phosphines, phosphinates, phosphonates, melamine resins (melamine cyanurates and melamine cyanurates), triphenyl phosphates diphenyl phosphates, polyamine 1,3,5-tris(3-amino-4-alkylphenyl)-2,4,6-trioxohexahydrotriazine, epoxy group containing glycidyl phosphate or glycidyl phosphinate, dihydro-9-oxa-10-phosphapheneantrene-10-oxide and its epoxidized variants, antimony trioxide, zinc borate and combinations thereof.

In another embodiment, the epoxy resin components utilized in the thermosettable epoxy resin composition of the present application include those resins produced from an epihalohydrin and an amine Suitable amines may include diamino diphenylmethane, aminophenol, xylene diamine, anilines, and the like, or combinations thereof. In another embodiment, the epoxy resins utilized in the embodiments of the disclosure include those resins produced from an epihalohydrin and a carboxylic acid. Suitable carboxylic acids may include phthalic acid, isophthalic acid, terephthalic acid, tetrahydro- and/or hexahydrophthalic acid, endomethylene tetrahydrophthalic acid, isophthalic acid, methyl hexahydrophthalic acid, and the like or combinations thereof.

In another embodiment, the epoxy resin components utilized include those resins produced from an epihalohydrin and compounds having at least one aliphatic hydroxyl group. In this embodiment, it is understood that such resin compositions produced contain an average of more than one aliphatic hydroxyl groups. Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such resin compositions produced contain an average of more than one aromatic hydroxyl groups. Examples of oxide adducts of compounds containing at least one aromatic hydroxyl group per molecule may include, but are not limited to, ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

In another embodiment the epoxy resin component may be an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon. A carboxyl substituted hydrocarbon which is described herein as a compound having a hydrocarbon backbone, preferably a C₁-C₄₀ hydrocarbon backbone, and one or more carboxyl moieties, preferably more than one, and most preferably two. The C₁-C₄₀ hydrocarbon backbone may be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, VERSATIC™ acids, available from Momentive Specialty Chemicals Inc., Columbus, Ohio, and decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In still another embodiment, the epoxy resin component may be the reaction product of a polyepoxide and a compound containing more than one isocyanate moiety or a polyisocyanate. In some embodiments, the epoxy resin that may be produced in such a reaction is an epoxy-terminated polyoxazolidone.

The epoxy resin component of the composition useful for preparing laminates is present as a weight percentage (wt %) of all components of the composition of from about 25 wt % to about 75 wt % percent. In some embodiments, the epoxy resin component is present as a weight percentage of all components of the composition of from about 35 wt % to about 65 wt % and in other embodiments it is present in a range of from about 40 wt % to about 60 wt %.

The preparation of epoxy resin compounds is well known in the art. Examples of epoxy resins and their precursors suitable for use in the compositions of some embodiments of the invention are also described, for example, in U.S. Pat. Nos. 5,137,990 and 6,451,898 which are fully incorporated herein by reference.

### Epoxidized Cycloaliphatic Dicyclopentadiene Phenolic Resin

The second component of the thermosettable epoxy resin composition useful for preparing laminates is an epoxidized cycloaliphatic dicyclopentadiene phenolic resin (epoxidized DCPD phenolic resin). The epoxidized cycloaliphatic dicyclopentadiene phenolic resins utilized in the compositions may include those resins produced from an epihalohydrin and a dicyclopentadiene polyphenolic compound having the general formula:

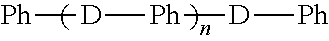

wherein “n” represents a whole number from 0 to 7; Ph is a phenylol radical derived from mononuclear phenol, and D is a tricyclodecylene radical having a general formula:

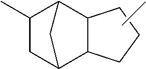

which may be methylated. In some embodiments, n is 0 or a whole number of from 1 to 3.

In at least one embodiment, phenol is used to prepare the tricyclodecylene radical while in others the phenylol radical may contain other organic constituent groups. The tricyclodecylene radical may be prepared by conversion of mono-nuclear phenols which possess at least one free ortho- and/or para-position relative to a phenolic hydroxyl group, with a dicyclopentadiene. Suitable phenols useful for this may include, for instance, phenol, o-, m-, and p-cresol, 3,4- and 3,5-dimethylphenol, the various alkyl phenols with in general not more than 15 carbon atoms per alkyl group, resorcinol, and mixtures of two or more phenols such as technical cresol.

In some embodiments, the dicyclopentadiene used to prepare the tricyclodecylene radical may be unsubstituted dicyclopentadiene. In other embodiments, a dimer of cyclopentadiene or a co-dimer of cyclopentadiene and methylcyclopentadiene may be so used.

The molar ratio in which the phenol and the dicyclopentadiene are caused to react may be between 1.5:1 and 15:1. In some embodiments of the application, the ratio may be between 4:1 and 10:1. Under the latter conditions the value of the number n in the aforementioned formula will usually equal zero.

The preparation of epoxidized cycloaliphatic dicyclopentadiene phenolic resin is well known in the art. Examples of such resins and their precursors suitable for use in the compositions of some embodiments of the invention are also described, for example, in U.S. Pat. No. 3,536,734, which is fully incorporated herein by reference.

The epoxidized cycloaliphatic dicyclopentadiene phenolic resin may be present in a range of from about 5 wt % to about 50 wt % as a weight percentage of all components of the composition. In some embodiments, the epoxidized cycloaliphatic dicyclopentadiene phenolic resin is present from about 10 wt % to about weight 40 wt %, and in other embodiments it is present in a range of from about 10 wt % to about 30 wt %, based upon the weight of all components of the composition.

### Liquid Oligomeric Butadiene Homopolymer Component

The liquid oligomeric butadiene homopolymer component is a homopolymer of butadiene having a weight average molecular weight (M_{w}) of from about 1,000 to about 20,000 Daltons. In some embodiments, this homopolymer will have a molar 1,2-vinyl group content of at least 25%. In some embodiments, the molar 1,2-vinyl group content may be from 5 to about 99% and, in other embodiments, from about 25 to about 95%. The liquid oligomeric butadiene homopolymer component may be present in the thermosettable epoxy resin composition of the invention in a concentration of from about 0.05 wt % to about 4 wt % as a weight percentage of all components in the composition. In some embodiment, this range may be from about 0.1 wt % to about 1.5 wt %, and in other embodiments, the range may be from about 0.2 wt % to about 1.0 wt % as a weight percentage of all components in the composition. These liquid homopolymers may be prepared using any method known to be useful to those of ordinary skill in the art of preparing liquid homopolymers of butadiene.

### Alkylphenol Novolac Curing Agent Component

The thermosettable epoxy resin compositions of the invention include a substituted novolac curing agent or a blend of differently substituted novolac curing agents, each represented by the general formula:

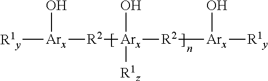

where: Ar represents an aryl or alkyl-aryl group; each Ar group contains x number of non-aromatic carbon atoms, OH represents a hydroxyl group bonded to each Ar group, R¹ represents substituent group(s) bonded to each Ar group, each R² represents a group connecting adjacent Ar groups, n is a number between 2 and 20, x is an integer from 4 to 8, y is an integer from 1 to x−2, and z is an integer from 1 to x−3.

In this general formula, each Ar may be the same or different and contains 5 to 7 carbon atoms and more preferably contains 6 carbon atoms; each R¹ may be the same or different and is an alkyl group or aryl group containing 2 to 20 carbon atoms, more preferably containing 4 to 9 carbon atoms and most preferably selected from a butyl, octyl or phenyl group; each R² may be the same or different and is an alkyl group, more preferably an alkyl group containing 1 to 5 carbon atoms, and most preferably a methyl or ethyl group; n is a number from 2 and 20 and preferably from 4 and 20.

In one embodiment, the curing agent may be a substituted novolac curing agent or a blend of differently substituted novolac curing agents each represented by the general formula:

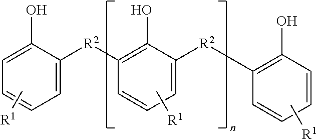

wherein R¹, R² and n are defined as above. And some embodiments, R¹ represents a single alkyl substituent in the para position having from 4 to 9 carbon atoms and is sometimes a butyl or octyl group. In one embodiment, R² is desirably in a methyl group.

In another embodiment, the substituted novolac curing agent is selected from octyl-phenol novolac, nonyl-phenol novolac, phenyl phenol novolac, t-butyl-phenol novolac, cardanol novolac, and combinations thereof. In a preferred embodiment the curing agent comprises a combination of octyl phenol novolac and butyl novolac.

In another embodiment, the substituted novolac curing agent comprises a co-novolac compound wherein R¹ represents a different alkyl groups on the same molecule. In this embodiment each R¹ is preferably an alkyl group, having from 4 to 15 carbon atoms, and is more preferably a butyl or octyl group. In a preferred embodiment, the curing agents comprise a co-novolac containing octyl and butyl substituent groups. In still another embodiment, the curing agent could comprise a co-novolac containing either phenol or bisphenol-A and an alkyl phenol.

In another embodiment, and in addition to the above, the substituted novolac curing agent comprises a compound wherein the weight average molecular weight (M_{w}) of the substituted novolac curing agent is between about 200 to about 20000 Daltons, sometime it is less than 4000, sometimes less than 3000 and in other embodiments between about 1000 and 4000, sometimes between about 1500 and 3000, and sometimes between about 1600 to 2700.

In yet another embodiment, the substituted novolac curing agent of the invention is utilized in combination with other curing agents known in the art such as for example, with unsubstituted phenol curing agents, or an amine- or amide-containing curing agent. Suitable unsubstituted phenol curing agents may include dihydroxy phenols, biphenols, bisphenols, halogenated biphenols, halogenated bisphenols, hydrogenated bisphenols, trisphenols, phenol-aldehyde resins, phenol-aldehyde novolac resins, halogenated phenol-aldehyde novolac resins, phenol-hydrocarbon resins, phenol-hydroxybenzaldehyde resins, alkylated phenol-hydroxybenzaldehyde resins, hydrocarbon-phenol resins, hydrocarbon-halogenated phenol resins, or combinations thereof. In some embodiments, the unsubstituted phenolic curing agent includes unsubstituted phenols, biphenols, bisphenols, novolacs or combinations thereof.

The ratio of curing agent to epoxy resin may be suitable to provide a fully cured resin. The amount of curing agent which may be present may vary depending upon the particular curing agent used (due to the cure chemistry and curing agent equivalent weight as is well known in the art). In one embodiment, the ratio of total epoxy groups to the phenolic hydroxyl equivalents may be between about 0.5 to about 1.5, sometimes between about 0.6 to about 1.2, and sometimes between about 0.8 to about 1.0.

### Poly(2,6-Dimethyl-1,4-Phenylene Oxide) Curing Agent Component

The thermosettable epoxy resin compositions of the invention also one or more poly(2,6-dimethyl-1,4-phenylene oxide), PPO, curing agents. The PPO curing agent component may be prepared using any method known to those of ordinary skill in the art to be useful. For example, these compounds may be prepared by using a surface-active coupling agent. Such a method is disclosed in the article, Dautenhahn & Lim, Biphasic Synthesis of Poly(2,6-dimethyl-1,4-phenylene oxide) Using a Surface-Active Coupling Agent, Ind. Eng. Chem. Res. 1992, 31, 463-469, which reference is fully incorporated herein by reference. In some embodiments, this component will have a Tg of about 210 and a dielectric constant of about 2.6. In some embodiments, the PPO curing agent component may have a phenolic equivalent weight of about 790 when substantially difunctional, but lower if significant monofunctional material is present.

In another embodiment, and in addition to the above, the PPO curing agent comprises a compound wherein the weight average molecular weight (M_{w}) of the substituted novolac curing agent is less than about 4000 Daltons, and sometimes between about 1500 to 4000.

The PPO curing agent component may be present in the compositions of the application at a level of as much as about 40 wt %. In some embodiments, the ratio of poly(2,6-dimethyl-1,4-phenylene oxide) to epoxidized cycloaliphatic dicyclopentadiene phenolic resin may be about 1:1, but in other embodiments, it may vary from about 0.7:1 to about 1.3:1.

### Organic Solvent Component

At least one solvent may optionally be used to prepare the thermosettable epoxy resin composition of the disclosure. In many embodiments, the solvent will be present at a weight concentration of from about 15 to about 50 wt % based upon the weight of all formulation components. The solvent or solvents may be present at a concentration of from about 20 to 40 wt % is some embodiments. Those of ordinary skill in the art of preparing laminates will well know how to select suitable solvents and what concentration of solvent to use for their particular applications.

Suitable solvents useful as the solvent component in some embodiments of the disclosure may include ketones, alcohols, glycol ethers, aromatic hydrocarbons and mixtures thereof. Other solvents which may be used with the process of the disclosure include, but are not limited to methyl ethyl ketone, methyl isobutyl ketone, propylene glycol methyl ether, ethylene glycol methyl ether, methyl amyl ketone, methanol, isopropanol, toluene, xylene, dimethylformamide and the like. A single solvent may be used, but in many embodiments, different solvents may be used for one or more of the components. For example, suitable solvents for the epoxy resin components may be ketones. Suitable solvents for the curing agent components detailed below may include, for example, ketones, amides such as dimethylformamide (DMF), ether alcohols such as methyl, ethyl, propyl or butyl ethers of ethylene glycol, diethylene glycol, propylene glycol or dipropylene glycol, ethylene glycol monomethyl ether, or 1-methoxy-2-propanol.

### Accelerator Component

Optional accelerators useful in the compositions of the invention include those compounds which catalyze the reaction of the epoxy resin with the curing agent.

In one embodiment, the accelerators are compounds containing amine, phosphine, heterocyclic nitrogen, ammonium, phosphonium, arsonium or sulfonium moieties. More preferably, the accelerators are heterocyclic nitrogen and amine-containing compounds and even more preferably, the accelerators are heterocyclic nitrogen-containing compounds.

In another embodiment, the heterocyclic nitrogen-containing compounds useful as accelerators include heterocyclic secondary and tertiary amines or nitrogen-containing compounds such as, for example, imidazoles, imidazolidines, imidazolines, bicyclic amidines, oxazoles, thiazoles, pyridines, pyrazines, morpholines, pyridazines, pyrimidines, pyrrolidines, pyrazoles, quinoxalines, quinazolines, phthalazines, quinolines, purines, indazoles, indazolines, phenazines, phenarsazines, phenothiazines, pyrrolines, indolines, piperidines, piperazines, as well as quaternary ammonium, phosphonium, arsonium or stibonium, tertiary sulfonium, secondary iodonium, and other related “onium” salts or bases, tertiary phosphines, amine oxides, and combinations thereof. Imidazoles as utilized herein include imidazole, 1-methylimidazole, 2-methylimidazole, 4-methylimidazole, 2-ethylimidazole, 2-ethyl-4-methylimidazole, 2-phenylimidazole, 2-undecylimidazole, 1-benzyl-2-methylimidazole, 2-heptadecyl imidazole, 4,5-diphenylimidazole, 2-isopropylimidazole, 2,4-dimethyl imidazole, 2-phenyl-4-methylimidazole, 1-cyanoethyl-2-ethyl-4-methylimidazole and the like. Preferred imidazoles include 2-methylimidazole, 2-phenylimidazole and 2-ethyl-4-methylimidazole.

Imidazolines as utilized herein include 2-methyl-2-imidazoline, 2-phenyl-2-imidazoline, 2-undecylimidazoline, 2-heptadecylimidazoline, 2-isopropylimidazole, 2,4-dimethyl imidazoline, 2-phenyl-4-methylimidazoline, 2-ethylimidazoline, 2-isopropylimidazoline, 4,4-dimethyl-2-imidazoline, 2-benzyl-2-imidazoline, 2-phenyl-4-methylimidazoline and the like.

Among preferred tertiary amines that may be used as accelerators are those mono- or polyamines having an open chain or cyclic structure which have all of the amine hydrogen replaced by suitable substituents, such as hydrocarbon radicals, and preferably aliphatic, cycloaliphatic or aromatic radicals. Examples of these amines include, among others, methyl diethanolamine, triethylamine, tributylamine, benzyl-dimethylamine, tricyclohexyl amine, pyridine, quinoline, and the like. Preferred amines are the trialkyl and tricycloalkyl amines, such as triethylamine, tri(2,3-dimethylcyclohexyl)amine, and the alkyl dialkanol amines, such as methyl diethanolamine and the trialkanolamines such as triethanolamine. Weak tertiary amines, e.g., amines that in aqueous solutions give a pH less than 10, are particularly preferred. Especially preferred tertiary amine accelerators are benzyldimethylamine and tris-(dimethylaminomethyl) phenol.

The amount of accelerator present may vary depending upon the particular curing agent used (due to the cure chemistry and curing agent equivalent weight as is known in the art).

### Use In Laminates

Laminates may be prepared using the thermosettable epoxy resin compositions of the disclosure by contacting the compositions with porous Substrates. The contacting may be performed using any method known to those skilled in the art. Examples of such contacting methods include powder coating, spray coating, die coating, coating and contacting the laminate substrate with a bath containing the composition. In one embodiment, the article is contacted with the composition in a bath.

The epoxy resin compositions described herein may be most commonly found in solution or dispersion. In those embodiments where the various compositions are in solution or dispersion, the various components of the composition may be dissolved or dispersed in the same solvent or may be separately dissolved in a solvent suitable for that component, then the various solutions are combined and mixed. Sometimes, when the epoxy resin composition is in the form of a solution or dispersion, it is referred to as a varnish.

The epoxy resin compositions described herein may optionally contain one or more known fillers in an amount sufficient to provide for reduced flammability, lowered coefficient of thermal expansion or improved thermal decomposition. The selection and nature of the fillers will vary depending upon the composition formulations as is known in the art. By way of example, such fillers include, but are not limited to, aerogels, alumina, calcium carbonate, clay, crystalline silica, fumed silica, fused silica, glass microspheres (hollow or solid), hydrogels, lyogels, mica, organogels, polymeric microspheres (hollow or solid), spodumene, talc, and the like, including any combination or subset thereof. The fillers, if utilized, are typically present in an amount of between about 5 wt % to about 30 wt %, based upon the weight of all components of the composition, and can vary in mean particle size from about 1 to about 15 microns. Also, by way of example, the filler may be pre-treated prior to their addition to the composition with additives such as adhesion promoters, stabilizers, thickeners and the like as is known in the art. Further, the filler may be utilized in the compositions in conjunction with dispersing or stabilizing agents to maintain a uniform suspension as is known to those skilled in the art.

Laminates, especially printed circuit boards, are required to have good physical properties, while simultaneously having good electrical insulating performance, especially at frequencies of around or above one GHz. Laminates prepared with conventional epoxy resin compositions often do not meet the newer, more stringent, specifications of modern manufacturers. An advantage of the laminates of the disclosure is that they may have balanced properties. That is, they may have the same physical properties as conventional laminates while having better electrical insulating properties.

Printed circuit boards prepared using epoxy resin compositions of the disclosure, have superior electrical performance, when compared to printed circuit boards and using conventional epoxy resin compositions. The physical properties of printed circuit boards of the disclosure are about as good as or even better than conventional printed circuit boards. The balanced properties of the laminates of the disclosure may be advantageous in electrical applications.

Another advantage of prepregs prepared using the epoxy resin compositions of the disclosure is that they, in some applications, may have a very smooth appearance. This smooth appearance is important in insuring good interlaminar adhesion and minimizing entrapped voids both of which can lower the performance of their laminates. Furthermore, prepregs with rough surfaces are more friable and the resulting prepreg resin dust can settle and subsequently cure on the surfaces of their copper clad laminates. These cured resin spots resist acid etching and produce circuitry defects. Also, prepregs are sold commercially and their appearance affects their commercial value. While not wishing to be bound by any theory, it is believed that the oligomeric butadiene homopolymer component of the epoxy resin compositions of the disclosure is responsible for the improvement. Especially in applications, where there is the possible development of rough surfaces during the prepreg processing, it is desirable to prepare the laminates with formulations including the oligomeric butadiene homopolymer component.

In addition to the advantages already stated, the inclusion of poly(2,6-dimethylphenylene oxide) reactive blends with epoxy resins in the method of the disclosure may provide significant improvement in dielectric properties (Dk & Df), moisture absorbance, toughness and flame retardancy without sacrificing the original epoxy resin's Glass Transition Temperature (Tg) and thermal performance (Td). The higher natural flame retardancy of the laminates prepared using poly(2,6-dimethylphenylene oxide) allows for a reduction in the amount of Br or other fire retardants necessary to meet some end-user specifications.

It should be noted that when poly(2,6-dimethylphenylene oxide) is used with conventional epoxy resin electrical laminating and composite solvents (ketones and glycol ethers) and processing conditions (forced air ovens at 320° F. and above), the laminate prepregs may have very poor surface appearance (very rough, bubbles and friable). This poor prepreg surface appearance is unacceptable, commercially, due to aesthetic reasons and reductions in their cured laminate interply adhesion, copper adhesion and resistance to solder shock after moisture exposure (among other unacceptable property reductions).

Historically, these poly(2,6-dimethylphenylene oxide)/epoxy blends have been processed conventionally using high concentrations (>20 wt %) of aromatic solvents (Toluene, Xylene, etc) and/or much lower forced air oven temperatures (<200° F.). Both of these approaches are undesirable in commercial prepregging manufacturing facilities due to employee safety concerns, increased air pollution issues, increased scrap and lowered manufacturing rates. The prepregs prepared using the method of this disclosure do not have such limitations.

In addition to high-performance electrical laminates, the resin compositions of the disclosure may find utility in, for example, molding powders, coatings, and structural composite parts fabrication. Examples of appropriate substrates for composites include fiber-containing materials such as woven cloth, mesh, mat, fibers, or the like, and combinations thereof. Preferably, such materials are made from glass or fiberglass, quartz, paper, polyethylene, poly(p-phenylene-terephthalamide), polyester, polytetrafluoroethylene, poly(p-phenylenebenzo-bisthiazole), carbon or graphite and the like. Preferred materials include glass or fiberglass, in woven cloth or mat form.

In order to provide a better understanding of the present invention including representative advantages thereof, the following examples are offered. However, this invention is by no means limited by these examples.

### EXAMPLES

Dielectric Constant (Dₖ)—This measurement was conducted per IPC-TM-650, Method 2.5.5.9 (IPC, Association Connecting Electronics Industry) using a Hewlett Packard Model 4291A RF Impedance/Material Analyzer. The precision of the results was typically +/−1%.

Dissipation Factor (D_{f})—This measurement was conducted per IPC-TM-650, Method 2.5.5.9 (IPC, Association Connecting Electronics Industry) using a Hewlett Packard Model 4291A RF Impedance/Material Analyzer. The precision of the results was typically +/−2 to 3%.

Glass Transition Temperature—The glass transition temperature (Tg) of the resin in the laminates was measured by Differential Scanning calorimetry (DSC) at a heat-up rate of 20° C./minute from 50° C. to 220° C. followed by rapid cooling and a second identical heating rate scan. The temperature of the DSC was calibrated using an indium and a tin standard. The DSC instrument was a Perkin Elmer DSC Model 7.

Molecular Weight via Gel Permeation Chromatography—The weight average molecular weight (M_{w}) herein is measured uses size exclusion gel permeation chromatography (GPC) which was calibrated using polystyrene molecular weight standards. A sample is dissolved in tetrahydrofuran and the resulting solution is run through a Hewlett Packard model 1100HPLC.

Prepreg Dust Gel Time—Approximately 0.2 grams of prepreg dust is placed upon the preheated (348° F.) surface of a hot plate that had been treated with a mold release agent. After 10 seconds, to allow the prepreg dust to melt, the mixture was repeatedly stroked to the left and to the right using a preheated 0.5 inch wide preheated stainless steel spatula having a wooden handle. With time, the mixture begins to polymerize and becomes a viscous stringy mass. Eventually, these strings no longer form between the gel plate and the spatula during the stroking process. The time from when the sample was placed upon the gel plate unto when this stringing ceases is considered as the Prepreg Dust Gel Time and it is recorded in seconds. This test was conducted in duplicate.

Prepreg Volatile Content—A 10.2 cm×10.2 cm piece of prepreg is conditioned at 50% Relative Humidity and 25° C. for four hours. It is then weighed to the nearest milligram (W₁). The prepreg is hung from a metal hook in a preheated oven at 163° C. for 15 minutes. It is the allowed to cool in a desiccator. The prepreg is then weighed to the nearest milligram (W₂). The volatile content of the prepreg is calculated as follows:

Volatile Content,wt %=((W₁−W₂)×100)/W₁

Resin Content—The resin content of the prepreg was measured using the procedures in IPC Test Method IPC-TM-650 2.3.16.2, “Treated Weight of Prepreg”.

Resin Flow—The resin flow of the prepreg was measured using the procedures in IPC Test Method IPC-TM-650 2.3.17, “Resin Flow Percent of Prepreg”.

Time to Delamination at Temperature—This test was conducted using the procedures in IPC Test Method IPC-TM-650 2.4.24.1, “Time to Delamination (TMA Method)”.

Total Burn Time—This test was conducted per IPC Test Method IPC-TM-650 2.3.10, “Flammability of Laminate”. The total burn time is the sum of the first and second burn times of five samples. No Individual burn time was greater than 10 seconds.

Varnish Gel Time—Three milliliters of an epoxy varnish formulation were placed on the surface of a preheated (348° F.) hot plate that had been treated with a mold release agent. After 15 seconds, to allow the majority of the organic solvent(s) to evaporate, the mixture was repeatedly stroked to the left and to the right using a preheated 0.5 inch wide preheated stainless steel spatula having a wooden handle. With time, the mixture begins to polymerize and becomes a viscous stringy mass. Eventually, these strings no longer form between the gel plate and the spatula during the stroking process. The time from when the sample was placed upon the gel plate unto when this stringing ceases is considered as the Varnish Gel Time and it is recorded in seconds.

Weight per Epoxide—The Weight per Epoxide (WPE & also known as the epoxy equivalent weight, EEW) was measured using an industry standard perchioric acid titration method.

### Comparative Example 1

### Conventional Dicyandiamide (DICY) Cured Laminating Resin for Lead Based Soldering Applications

This comparative example provides: a typical, historical electrical laminating resin formulation used for lead based Printed Circuit Board (PCB) solder applications; its prepregging characteristics; and its neat resin and laminate properties. It is presented as a basis for comparison with the proposed formulation improvements provided in this patent.

A varnish composition was prepared from its components according to Table 1. A Brominated Bisphenol of Acetone epoxy resin (having a weight per Epoxide, WPE, from 428 to 442 grams per equivalent; containing 18.2 to 20.5 weight percent bromine, solids basis; and, dissolved in acetone at 79.5 to 80.5 weight percent solids (available from Momentive Specialty Chemicals Inc. under the brand name EPON® Resin 1124-A-80) was combined first with a solution composed of 7 weight percent DICY dissolved in 93 weight percent ethylene glycol monomethyl ether (MeOX) and then combined with a solution composed of 10 weight percent 2-methyl imidazole (2MI) dissolved in 90 weight percent MeOX. This mixture was thoroughly stirred until homogenous. The gel time of this reactive varnish mixture was determined to be 117 seconds (at 171° C.).

This varnish was used to impregnate 33 cm×33 cm pieces of woven glass cloth (glass cloth style 7628 with glass binder type 643 available from BGF Industries Inc.). This material is an industrial grade fiberglass cloth commonly utilized in the electrical laminating industry.

A pre-measured quantity of the varnish solution was applied to the fiberglass cloth manually and the varnish was uniformly distributed and worked into the fiberglass cloth using a paintbrush. The resulting varnish impregnated fiberglass cloth was hung in an air-circulating oven at 165° C. to remove its volatile solvents (volatile Content <1.0 wt %) and to partially cure the varnish's reactive components. Each sheet of prepreg (Resin Content >45 wt %) was kept in the air-circulating oven for 2.75 minutes. This laboratory prepreg preparation process emulates the commercial manufacturing of industrial electrical laminating prepregs.

After allowing the prepreg to cool to room temperature, the surface appearance of this laboratory prepared prepreg was judged to be excellent. It was transparent, shiny and contained no surface defects such as craters, pinholes, “orange peel” nor resin sags. The partially cured resin in each prepreg sheet was subjected to mechanical abrasion to physically remove it from the fiberglass cloth. Any remaining glass fibers in this prepreg dust were then separated from the partially cured resin dust. A selected amount of this prepreg dust was placed into a rectangular cavity mold and it was inserted between temperature controlled platens of a laboratory press (Tetrahedron Associates, Incorporated, model 1402). The polymerization of the neat resin prepreg dust was completed using the following cure cycle:
(1) apply 0.64 MPa pressure to the mold;
(2) increase the temperature of the mold from room temperature to 182.2° C. at 5.6° C. per minute; upon reaching 182.2° C., hold at this temperature for approximately 1 hour;
(3) cool under pressure from 182.2° C. to 40.6° C. at 5.6° C. per minute; and,
(4) release the pressure and remove the cured neat resin casting from the mold.

The dielectric constant and dissipation of this neat casting was then measured at room temperature using the methods described earlier in this section. These measured values can be found in Table 1.

In addition to making neat resin castings from the prepregs described above, other similar prepregs were prepared using slightly longer oven times and lower resin contents (40+/−2 wt %). They were then cured under pressure (0.69 MPa), using the previously described cure cycle, into 8 ply fiberglass laminates (with resin contents typically between 36 and 39 wt % and resin flow of approximately 14%). The properties of these laminates are reported in Table 1.

### Comparative Example 2

### Conventional Novolac Cured Laminating Resin for Lead-Free Based Soldering Applications

This comparative example provides: a typical, historical electrical laminating resin formulation used for lead-free PCB solder applications; its prepregging characteristics; and its neat resin and laminate properties. It is presented as a basis for comparison with the proposed formulation improvements provided in this patent.

The varnish composition of Comparative Example 2 was prepared from its components according to Table 1 and the procedures described in Comparative Example 1. The varnish was prepared using an epoxidized phenolic novolac resin dissolved in Acetone (having a WPE of 176 to 181 available from Momentive Specialty Chemicals Inc. as EPON Resin 154-A-80. This solution was 80% by weight EPON Resin 154 and 20% by weight Acetone.), an epoxidized multifunctional resin (having a WPE of 200 to 240 available from Momentive Specialty Chemicals as EPON Resin 1031), a diglycidyl ether from epichlorohydrin and tetrabromobisphenol of acetone (having a WPE from 380 to 410 and containing 50 weight percent bromine available from Momentive Specialty Chemicals Inc. as EPON Resin 1163), acetone and 1-methoxy-2-propanol (propylene glycol monomethyl ether, PGME). To this resin mixture was added a phenolic novolac (with a Weight Average Molecular Weight, M_{w} of 1610 and residual monomer content of less than 1.0 weight percent available from Momentive Specialty Chemicals Inc. as DURITE® SD-1702). The phenolic novolac was allowed to completely dissolve, at ambient temperature with mechanical agitation, into the resin solution. A solution of 10 weight percent 2MI and 90 weight percent PGME was then added into the previously made resin solution with stirring. The gel time of this reactive varnish was 191 seconds. Each sheet of prepreg was kept in the air-circulating oven for 3.00 minutes. After allowing the prepreg to cool to room temperature, the surface appearance of this laboratory prepared prepreg was judged to be excellent. It was transparent, shiny and contained no surface defects such as craters, pinholes, “orange peel” nor resin sags. The measured dielectric constant and dissipation of neat resin castings of this formulation can be found in Table 1. Eight ply laminates were also made as described in Comparative Example 1 and their properties are reported in Table 1.

### Comparative Example 3

### Conventional Novolac Cured Laminating Resin for Lead-Free Based Soldering Applications with Enhanced Electrical Performance Composed of Type I Alkylphenol Novolac

This comparative example provides: a typical, historical electrical laminating resin formulation used for lead-free PCB solder applications with enhanced electrical performance; its prepregging characteristics; and its neat resin and laminate properties. It is presented as a basis for comparison with the proposed formulation improvements provided in this patent.

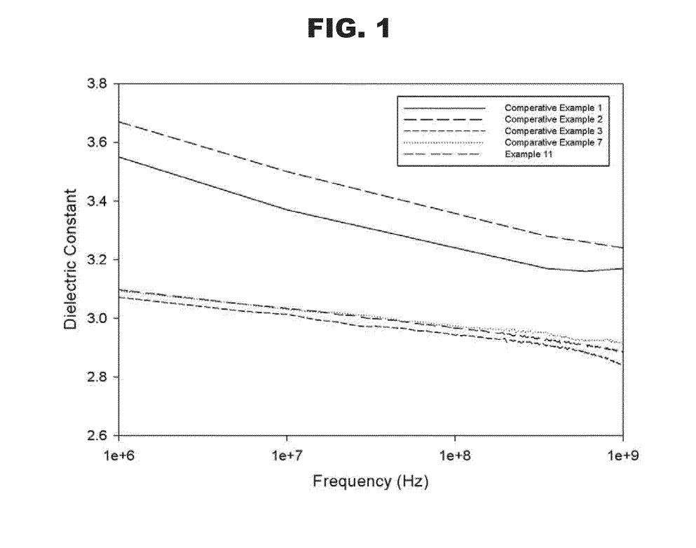

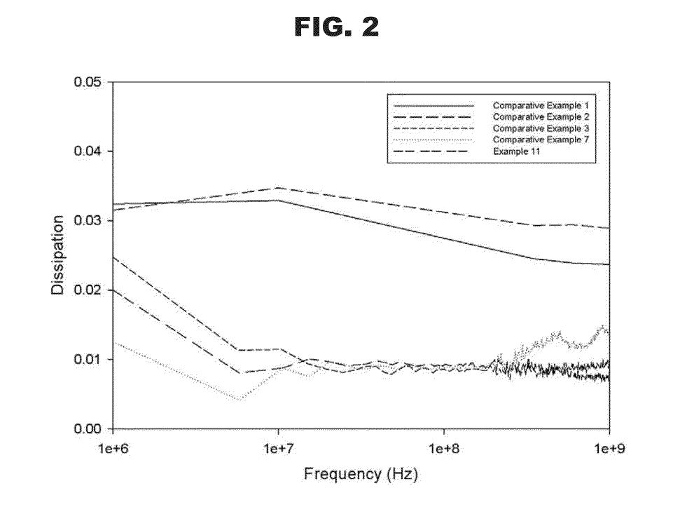

The varnish composition of Comparative Example 3 was prepared from its components according to Table 1 and the procedures described in Comparative Example 1. The varnish was prepared using an epoxidized DCPD phenolic resin (having a WPE of 285), EPON Resin 1031 and EPON Resin 1163. To this resin mixture was added a para-tertiary-methylbutylphenol novolac (commonly referred to as Octylphenol novolac, defined as Type I alkylphenol novolac) with a Weight Average Molecular Weight, M_{w} of 1715 and residual monomer content of less than 1.0 weight percent. The Octylphenol novolac was allowed to completely dissolve, at ambient temperature with mechanical agitation, into the resin solution. A solution of 10 weight percent 2MI and 90 weight percent PGME was then added into the previously made resin solution with stirring. The gel time of this reactive varnish was 204 seconds. Each sheet of prepreg was kept in the air-circulating oven for 5.00 minutes. After allowing the prepreg to cool to room temperature, the surface appearance of this laboratory prepared prepreg was judged to be very poor. It was transparent and contained craters and blister surface defects along with some resin sags. The measured dielectric constant and dissipation of neat resin castings of this formulation can be found in Table 1 and FIGS. 1 and 2. Eight ply laminates were also made as described in Comparative Example 1 and their properties are reported in Table 1.

### Comparative Example 4

### Conventional Novolac Cured Laminating Resin for Lead-Free Based Soldering Applications with Enhanced Electrical Performance Composed of Type II Alkylphenol Novolac

This comparative example provides: a typical, historical electrical laminating resin formulation used for lead-free PCB solder applications with enhanced electrical performance; its prepregging characteristics; and its neat resin and laminate properties. It used an alternative curing agent than that in Comparative Example 3. It is presented as a basis for comparison with the proposed formulation improvements provided in this patent.

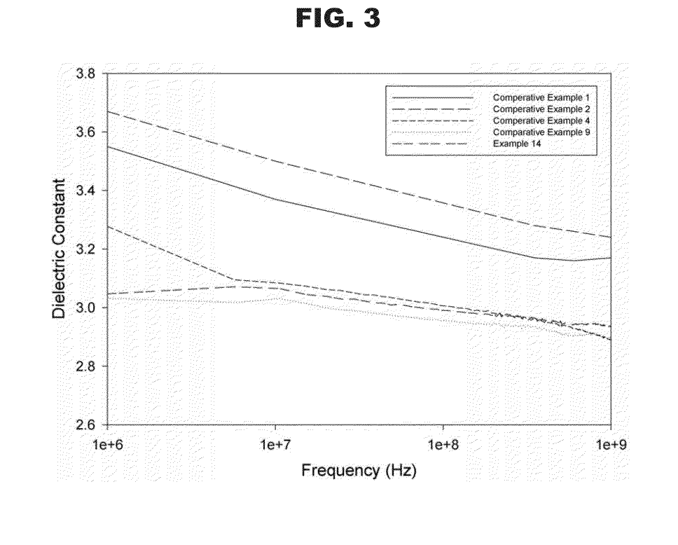

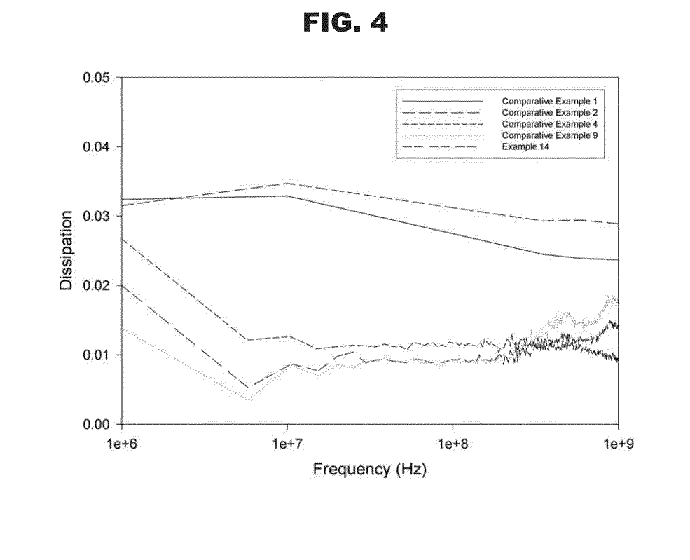

The varnish composition of Comparative Example 4 was prepared from its components according to Table 1 and the procedures described in Comparative Example 1. Its composition was very similar with Comparative Example 3 with the replacement of its Octylphenol novolac by a co-novolac composed of Octylphenol and tert-Butylphenol (Type II alkylphenol novolac). The varnish was prepared using an epoxidized DCPD phenol resin (having a WPE of 285), EPON Resin 1031 and EPON Resin 1163. To this resin mixture was added a co-novolac composed of Octylphenol and tert-Butylphenol with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 10 weight percent 2MI and 90 weight percent PGME was then added into the resin solution with stirring. The gel time of this reactive varnish was 204 seconds. Each sheet of prepreg was kept in the air-circulating oven for 5.00 minutes. After allowing the prepreg to cool to room temperature, the surface appearance of this laboratory prepared prepreg was judged to be very poor. It was not transparent or shiny and it contained extensive surface craters and blister defects along with large resin sags. The measured dielectric constant and dissipation of neat resin castings of this formulation can be found in Table 1 and FIGS. 3 and 4. Eight ply laminates were also made as described in Comparative Example 1 and their properties are reported in Table 1.

### Comparative Example 5

### Conventional Novolac Cured Laminating Resin for Lead-Free Based Soldering Applications with Superior Electrical Performance Composed of Type I Alkylphenol Novolac and Standard Molecular Weight PPO

This comparative example provides: a typical, historical electrical laminating resin formulation used for lead-free PCB solder applications with superior electrical performance; its prepregging characteristics; and its neat resin and laminate properties. It is presented as a basis for comparison with the proposed formulation improvements provided in this patent.

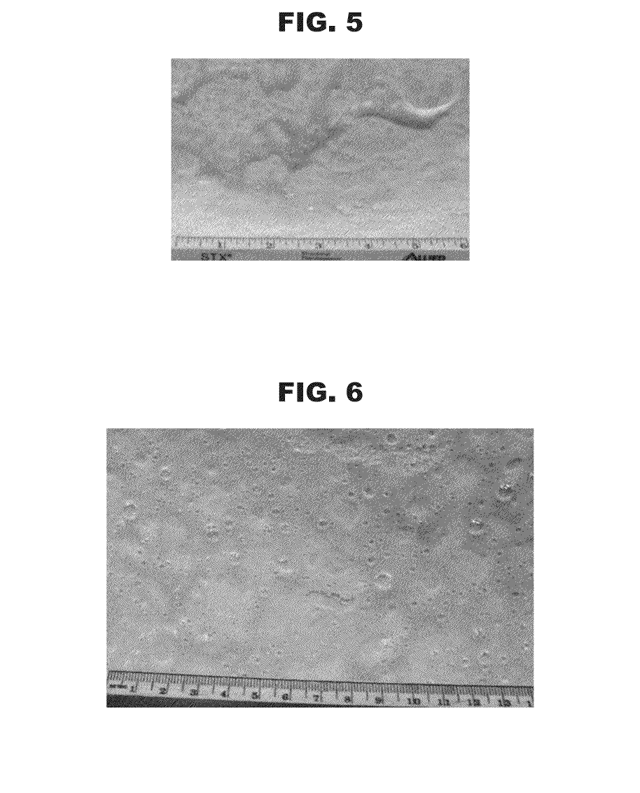

The varnish composition of Comparative Example 5 was prepared from its components according to Table 2 and the procedures described in Comparative Example 1. Its composition was very similar with Comparative Example 3 with the addition of a standard molecular weight PPO. The varnish was prepared using an epoxidized DCPD phenol resin (having a WPE of 285), EPON Resin 1031 and EPON Resin 1163. To this resin mixture was added an Octylphenol novolac with a Weight Average Molecular Weight, M, of 1715 and residual monomer content of less than 1.0 weight percent. The Octylphenol novolac was allowed to completely dissolve, at ambient temperature with mechanical agitation, into the resin solution. A solution of 50 weight percent poly(2,6-dimethyl-1,4-phenylene oxide, PPO) with a M_{w} of 3605 and a Polydispersity Index (PDᵢ) [defined as Standard Molecular Weight PPO] of 1.96 dissolved in MEK was then added with stifling into the previously made resin solution. The PPO was made without using a redistribution or rearrangement reaction and it did not contain any metal salt compatibilizers. A solution of 10 weight percent 2MI and 90 weight percent PGME was then added into the resin solution with stirring. The gel time of this reactive varnish was 240 seconds. Each sheet of prepreg was kept in the air-circulating oven for 4.00 minutes. After allowing the prepreg to cool to room temperature, the surface appearance of this laboratory prepared prepreg was judged to be very poor. It was not transparent or shiny and it contained extensive surface craters and blister defects with large resin sags. FIG. 5 provides a representative photograph of this prepreg. Eight ply laminates were made as described in Comparative Example 1 and their properties are reported in Table 1.

TABLE 1

| | Parts (grams) | | | | |
|---|---|---|---|---|---|
| | Comparative Example Number | | | | |
| Component | 1 | 2 | 3 | 4 | 5 |
| EPON Resin | 303.70 | — | — | — | — |
| 1124-A-80 | | | | | |
| EPON Resin | — | 14.32 | 3.38 | 2.98 | 3.03 |
| 1031 | | | | | |
| EPON Resin | — | 53.96 | — | — | — |
| 154-A-80 | | | | | |
| EPON Resin | — | 43.15 | 29.26 | 27.79 | 28.09 |
| 1163 | | | | | |
| Epoxidized | — | — | 29.46 | 32.40 | 18.31 |
| DCPD phenolic | | | | | |
| resin | | | | | |
| Phenolic | — | 39.47 | — | — | — |
| Novolac | | | | | |
| Octylphenol | — | — | 63.31 | — | 39.05 |
| Novolac-B-65 | | | | | |
| Octylphenol/ | — | — | — | 36.08 | — |
| tert-butyl- | | | | | |
| phenol | | | | | |
| Co-novolac | | | | | |
| PPO-B-50 | — | — | — | — | 50.76 |
| MEK | — | — | 1.46 | 11.17 | — |
| Acetone | — | 29.21 | 17.32 | 30.61 | — |
| PGME | — | 17.11 | 7.50 | 7.47 | 8.03 |
| 7% DICY/ | 100.53 | — | — | — | — |
| 93% MeOX | | | | | |
| 10% 2MI/ | 2.70 | — | — | — | |
| 90% MeOX | | | | | |
| 10% 2MI/ | — | 0.71 | 6.01 | 4.78 | 4.07 |
| 90% PGME | | | | | |
| Varnish Gel | 117 | 191 | 204 | 196 | 240 |
| Time (seconds) | | | | | |
| Prepreg Oven | 2.75 | 3.00 | 5.00 | 5:00 | 4.00 |
| Time (minutes) | | | | | |
| Prepreg | Excellent | Excellent | Very | Very | Very |
| Appearance | | | Poor | Poor | Poor |
| T_{g} (DSC, ° C., | 137 | 157 | 176 | 176 | 176 |
| 2^{nd} heat)* | | | | | |
| T_{d} (TGA, ° C., | 295 | 337 | 329 | 331 | 331 |
| 5% wt loss)* | | | | | |
| Electrical | | | | | |
| Properties** | | | | | |
| Dₖ @ 1 GHz | 3.17 | 3.24 | 2.84 | 2.89 | — |
| D_{f} @ 1 GHz | 0.0237 | 0.0289 | 0.0090 | 0.0093 | — |

*Laminate properties;
**Neat Casting Properties
In Table 1, “A” denotes acetone, “B” denotes MEK with the number afterwards denoting the wt % of the solid.

### Comparative Example 6

### Conventional Novolac Cured Laminating Resin for Lead-Free Based Soldering Applications with Superior Electrical Performance Composed of Type II Alkylphenol Novolac and a Standard Molecular Weight PPO

This example provides: an electrical laminating resin formulation used for lead-free PCB solder applications with superior electrical performance and enhanced prepreg appearance; its prepregging characteristics; and its neat resin and laminate properties. It is presented as a basis for comparison with the proposed formulation improvements provided in this patent.

The varnish composition of Example 6 was prepared from its components according to Table 2 and the procedures described in Comparative Example 1. Its composition was very similar with Comparative Example 4 with the addition of PPO. Its varnish was prepared using an epoxidized DCPD phenol resin (having a WPE of 285), EPON Resin 1031, and EPON Resin 1163. To this resin mixture was added a co-novolac composed of Octylphenol and tert-Butylphenol with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 50 weight percent poly(2,6-dimethyl-1,4-phenylene oxide, PPO) with a M_{w} of 3605 and a Polydispersity Index (PDᵢ) of 1.96 dissolved in MEK was then added with stirring into the previously made resin solution. The PPO was made without using a redistribution or rearrangement reaction and it did not contain any metal salt compatibilizers. A solution of 10 weight percent 2MI and 90 weight percent PGME was then added into the resin solution with stirring. The gel time of this reactive varnish was 226 seconds. Each sheet of prepreg was kept in the air-circulating oven for 4.50 minutes. Eight ply laminates were also made as described in Comparative Example 1 and their properties are reported in Table 2. After allowing the prepreg to cool to room temperature, the surface appearance of this laboratory prepared prepreg was judged to be very poor. It was not transparent or shiny and it contained extensive surface craters and blister defects with large resin sags. FIG. 6 provides a representative photograph of this prepreg. Eight ply laminates were made as described in Comparative Example 1 and their properties are reported in Table 2.

### Comparative Example 7

### Conventional Novolac Cured Laminating Resin for Lead-Free Based Soldering Applications with Superior Electrical Performance Composed of a Type I Alkylphenol Novolac and a Higher Concentration (than used in Comparative Example 5) of the Standard Molecular Weight PPO

This comparative example provides: a typical, historical electrical laminating resin formulation used for lead-free PCB solder applications with superior electrical performance; its prepregging characteristics; and its neat resin and laminate properties. It is presented as a basis for comparison with the proposed formulation improvements provided in this patent.

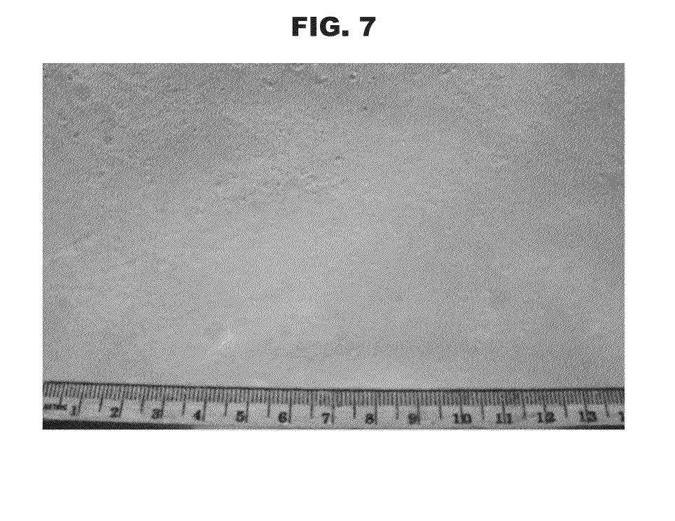

The varnish composition of Comparative Example 7 was prepared from its components according to Table 2 and the procedures described in Comparative Example 1. Its composition was very similar with Comparative Example 5 except a higher concentration of the standard molecular weight PPO was utilized. The varnish was prepared using an epoxidized DCPD phenol resin solution (having a WPE of 285) that was 75 wt % epoxidized DCPD phenolic resin and 25 wt % MEK, EPON Resin 1031, and EPON Resin 1163. To this resin mixture was added an Octylphenol novolac with a Weight Average Molecular Weight, M_{w} of 1715 and residual monomer content of less than 1.0 weight percent. The Octylphenol novolac was allowed to completely dissolve, at ambient temperature with mechanical agitation, into the resin solution. A solution of 50 weight percent poly(2,6-dimethyl-1,4-phenylene oxide, PPO) with a M_{w} of 3605 and a Polydispersity Index (PDᵢ) of 1.96 dissolved in MEK was then added with stirring into the previously made resin solution. The PPO was made without using a redistribution or rearrangement reaction and it did not contain any metal salt compatibilizers. A solution of 10 weight percent 2MI and 90 weight percent PGME was then added into the resin solution with stirring. The gel time of this reactive varnish was 195 seconds. Each sheet of prepreg was kept in the air-circulating oven for 4.50 minutes. After allowing the prepreg to cool to room temperature, the surface appearance of this laboratory prepared prepreg was judged to be very poor. It was not transparent or shiny and it contained extensive surface craters and blister defects with large resin sags. FIG. 7 provides a representative photograph of this prepreg. A neat resin casting was made as described in Comparative Example 1; and, its electrical properties are reported with those of Example 11. Eight ply laminates were made as described in Comparative Example 1 and their properties are also reported in Table 2.

### Comparative Example 8

### Conventional Novolac Cured Laminating Resin for Lead-Free Based Soldering Applications with Superior Electrical Performance Compose of a Type I Alkylphenol Novolac with a Lower Molecular Weight PPO

This example provides: an electrical laminating resin formulation used for lead-free PCB solder applications with superior electrical performance; its prepregging characteristics; and its neat resin and laminate properties.

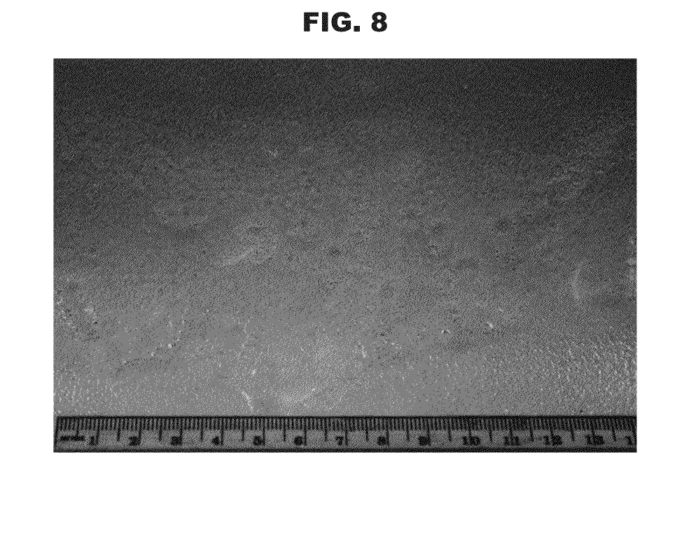

The varnish composition of Example 8 was prepared from its components according to Table 2 and the procedures described in Comparative Example 1. Its composition is very similar to Comparative Example 5 except it contained a lower molecular weight PPO component. Its varnish was prepared using an epoxidized DCPD phenol resin (having a WPE of 285), EPON Resin 1031, and EPON Resin 1163. To this resin mixture was added an Octylphenol novolac (with a Weight Average Molecular Weight, M_{w} of 1715 and residual monomer content of less than 1.0 weight percent. This Octylphenol novolac was allowed to completely dissolve, at ambient temperature with mechanical agitation, into the resin solution. A solution of 50 weight percent poly(2,6-dimethyl-1,4-phenylene oxide, PPO) with a M_{w} of 2573 and a Polydispersity Index (PDᵢ) of 1.86 [defined as a Low Molecular Weight PPO] dissolved in MEK was then added with stirring into the previously made resin solution. The PPO was made without using a redistribution or rearrangement reaction and it did not contain any metal salt compatibilizers. A solution of 10 weight percent 2MI and 90 weight percent PGME was then added into the resin solution with stirring. The gel time of this reactive varnish was 231 seconds. Each sheet of prepreg was kept in the air-circulating oven for 4.25 minutes. After allowing the prepreg to cool to room temperature, the surface appearance of this laboratory prepared prepreg was judged to be poor. It was slightly transparent, dull and it contained some small craters and blister defects with some resin sags. FIG. 8 provides a representative photograph of this prepreg. Eight ply laminates were also made as described in Comparative Example 1 and their properties are reported in Table 2.

### Comparative Example 9

### Conventional Novolac Cured Laminating Resin for Lead-Free Based Soldering Applications with Superior Electrical Performance Composed of a Type II Alkylphenol Novolac and a Higher Concentration (than used in Comparative Example 6) of the Standard Molecular Weight PPO

This example provides: an electrical laminating resin formulation used for lead-free PCB solder applications with superior electrical performance and enhanced prepreg appearance; its prepregging characteristics; and its neat resin and laminate properties. It is presented as a basis for comparison with the proposed formulation improvements provided in this patent.

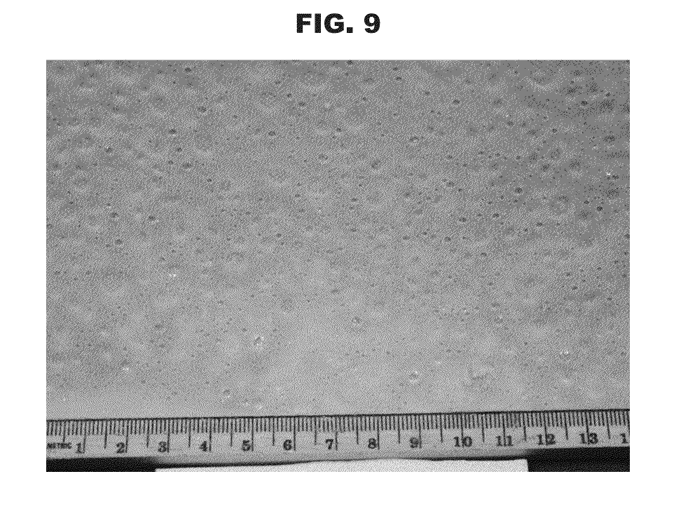

The varnish composition of Example 9 was prepared from its components according to Table 2 and the procedures described in Comparative Example 1. Its composition was very similar with Comparative Example 6 except it uses a higher PPO concentration. Its varnish was prepared using an epoxidized DCPD phenol resin solution (having a WPE of 285) that was 75 wt % epoxidized DCPD phenolic resin and 25 wt % MEK, EPON Resin 1031, and EPON Resin 1163. To this resin mixture was added a co-novolac composed of Octylphenol and tert-Butylphenol with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 50 weight percent poly(2,6-dimethyl-1,4-phenylene oxide, PPO) with a M, of 3605 and a Polydispersity Index (PDᵢ) of 1.96 dissolved in MEK was then added with stirring into the previously made resin solution. The PPO was made without using a redistribution or rearrangement reaction and it did not contain any metal salt compatibilizers. A solution of 10 weight percent 2MI and 90 weight percent PGME was then added into the resin solution with stirring. The gel time of this reactive varnish was 195 seconds. Each sheet of prepreg was kept in the air-circulating oven for 4.50 minutes. After allowing the prepreg to cool to room temperature, the surface appearance of this laboratory prepared prepreg was judged to be very poor. It was slightly transparent, dull and it contained some small craters and blister defects with some resin sags. A neat resin casting was made as described in Comparative Example 1; and, its electrical properties are reported with those of Example 14. Eight ply laminates were also made as described in Comparative Example 1 and their properties are reported in Table 2. FIG. 9 provides a representative photograph of this prepreg.

### Comparative Example 10

### Conventional Novolac Cured Laminating Resin for Lead-Free Based Soldering Applications with Superior Electrical Performance Composed of a Type II Alkylphenol Novolac with a Lower Molecular Weight PPO

This example provides: an electrical laminating resin formulation used for lead-free PCB solder applications with superior electrical performance and enhanced prepreg appearance; its prepregging characteristics; and its neat resin and laminate properties. It is presented as a basis for comparison with the proposed formulation improvements provided in this patent.

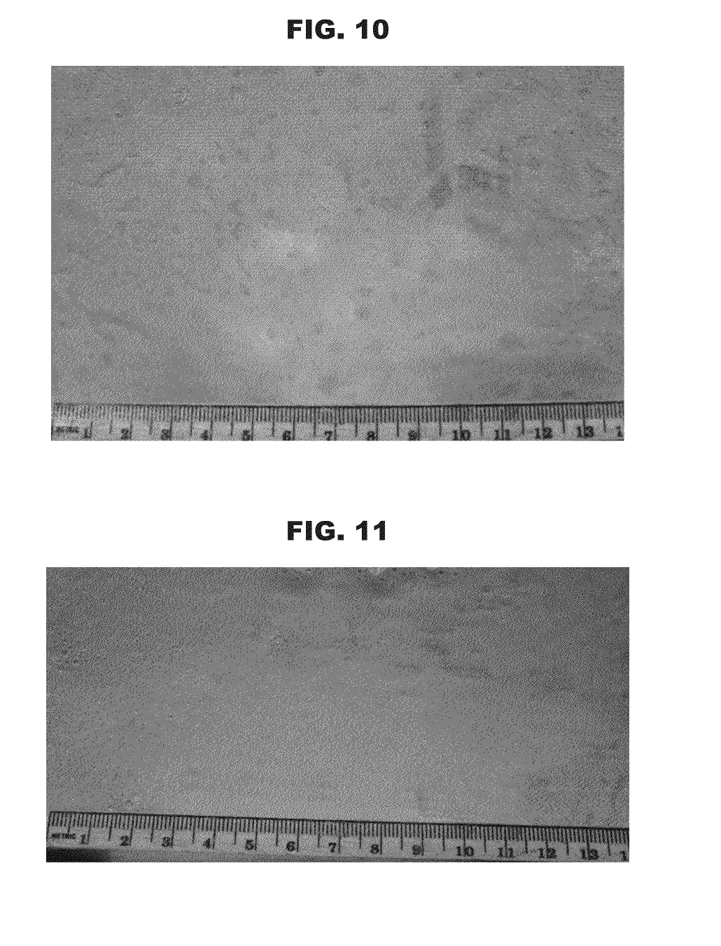

The varnish composition of Example 9 was prepared from its components according to Table 2 and the procedures described in Comparative Example 1. Its composition was very similar with Comparative Example 6 except it uses a lower molecular weight PPO. Its varnish was prepared using an epoxidized DCPD phenol resin (having a WPE of 285), EPON Resin 1031, and EPON Resin 1163. To this resin mixture was added a co-novolac composed of Octylphenol and tert-Butylphenol with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 50 weight percent poly(2,6-dimethyl-1,4-phenylene oxide, PPO) with a M_{w} of 2573 and a Polydispersity Index (PDᵢ) of 1.86 dissolved in MEK was then added with stirring into the previously made resin solution. The PPO was made without using a redistribution or rearrangement reaction and it did not contain any metal salt compatibilizers. A solution of 10 weight percent 2MI and 90 weight percent PGME was then added into the resin solution with stirring. The gel time of this reactive varnish was 208 seconds. Each sheet of prepreg was kept in the air-circulating oven for 4.50 minutes. After allowing the prepreg to cool to room temperature, the surface appearance of this laboratory prepared prepreg was judged to be marginally acceptable/poor. It was slightly transparent, mostly shiny and it contained a few small craters and blister defects with some resin sags. Eight ply laminates were made as described in Comparative Example 1 and their properties are reported in Table 2. FIG. 10 provides a representative photograph of this prepreg.

TABLE 2

| | Parts (grams) | | | | |
|---|---|---|---|---|---|
| | Comparative Example Number | | | | |
| Component | 6 | 7 | 8 | 9 | 10 |
| EPON Resin 1031 | 2.98 | 3.00 | 2.98 | 3.00 | 3.00 |
| EPON Resin 1163 | 27.97 | 28.00 | 27.97 | 28.01 | 28.02 |
| Epoxidized | — | 20.97 | — | 24.83 | — |
| DCPD Phenol | | | | | |
| Novolac-B-75 | | | | | |
| Epoxidized | 21.75 | — | 18.98 | — | 22.42 |
| DCPD Phenol | | | | | |
| Novolac | | | | | |
| Octylphenol | — | 33.00 | 38.49 | — | — |
| Novolac-B-65 | | | | | |
| Octylphenol/ | 36.41 | — | — | 30.99 | 35.83 |
| tert-butyl- | | | | | |
| phenol | | | | | |
| Co-novolac- | | | | | |
| B-65 | | | | | |
| PPO-B-50 | 47.24 | 64.11 | 50.03 | 60.51 | 46.62 |
| MEK | 9.65 | — | | — | 15.34 |
| PGME | 15.49 | 12.59 | 28.22 | 14.13 | 10.56 |
| 10% 2MI/ | 4.04 | 4.25 | 4.49 | 3.50 | 5.01 |
| 90% PGME | | | | | |
| Varnish Gel | 226 | 195 | 231 | 195 | 208 |
| Time (seconds) | | | | | |
| Prepreg Oven | 4.50 | 4.50 | 4.25 | 4.50 | 4.50 |
| Time (minutes) | | | | | |
| Prepreg | Very | Very | Poor | Very | Marginally |
| Appearance | Poor | Poor | | Poor | Acceptable/ |
| | | | | | Poor |
| T_{g} (DSC, ° C., | 179 | 170 | 168 | 180 | 176 |
| 2^{nd} heat)* | | | | | |
| T_{d} (TGA, ° C., | 331 | 331 | 312 | 324 | 323 |
| 5% wt loss)* | | | | | |

*Laminate properties
In Table 2, “A” denotes acetone, “B” denotes MEK with the number afterwards denoting the wt % of the solid.

### Example 11

### Conventional Novolac Cured Laminating Resin for Lead-Free Based Soldering Applications with Superior Electrical Performance and Enhanced Prepreg Appearance Composed of a Type I Alkylphenol Novolac with a Lower Molecular Weight PPO (at a Similar Concentration as Used in Comparative Example 7) and an Oligomeric Butadiene Homopolymer

This example provides: an electrical laminating resin formulation used for lead-free PCB solder applications with superior electrical performance and enhanced prepreg appearance; its prepregging characteristics; and its neat resin and laminate properties.

The varnish composition of Example 11 was prepared from its components according to Table 3 and the procedures described in Comparative Example 1. Its composition is very similar to Comparative Example 7 except it contained an oligomeric butadiene homopolymer to provide enhanced surface appearance. Its varnish was prepared using an epoxidized DCPD phenol resin solution (having a WPE of 285) that was 85% by weight epoxidized DCPD phenolic resin and 30% by weight MEK, EPON Resin 1031, and EPON Resin 1163. To this resin mixture was added an octylphenol novolac (with a Weight Average Molecular Weight, M_{w} of 1715 and residual monomer content of less than 1.0 weight percent. This octylphenol novolac was allowed to completely dissolve, at ambient temperature with mechanical agitation, into the resin solution. A solution of 50 weight percent poly(2,6-dimethyl-1,4-phenylene oxide, PPO) with a M_{w} of 2573 and a Polydispersity Index (PDᵢ) of 1.86 dissolved in MEK was then added with stirring into the previously made resin solution. The PPO was made without using a redistribution or rearrangement reaction and it did not contain any metal salt compatibilizers. A solution containing 25 wt % oligomeric butadiene homopolymer dissolved in 75 wt % toluene was added to the resin solution with stirring. The oligomeric butadiene homopolymer had a M, value of 8490 and a molar 1,2-vinyl content of 85 wt %. A solution of 10 weight percent 2MI and 90 weight percent PGME was then added into the resin solution with stirring. The gel time of this reactive varnish was 197 seconds. Each sheet of prepreg was kept in the air-circulating oven for 5.00 minutes. After allowing the prepreg to cool to room temperature, the surface appearance of this laboratory prepared prepreg was judged to be excellent. It was transparent, shiny and it contained a very few small craters and blister defects with minimum resin sags. FIG. 11 provides a representative photograph of this prepreg. A comparison of this Figure with FIG. 7 illustrates the improvement in prepreg appearance with the addition of the oligomeric butadiene homopolymer. A neat resin casting was made as described in Comparative Example 1; and, its electrical properties are reported in Table 3 and FIG. 1 and FIG. 2. Eight ply laminates were also made as described in Comparative Example 1 and their properties are reported in Table 3.

TABLE 3

| | Resin Characteristics | | | | |
|---|---|---|---|---|---|
| | | | | | Lead Free, Superior |
| | | | Lead Free, Improved, | Lead Free, Superior | Electricals, Type I |
| | | | Electricals Type I | Electricals, Type I | Novolac, Enhanced |
| | Lead Based | Lead Free | Novolac | Novolac | Appearance |
| | Parts (grams) | | | | |
| | Comparative Example Number | | | | Example |
| Component | 1 | 2 | 3 | 7 | 11 |
| EPON Resin 1124-A-80 | 303.70 | — | — | — | — |
| EPON Resin 1031 | — | 14.32 | 3.38 | 3.00 | 3.00 |
| EPON Resin 154-A-80 | — | 53.96 | — | — | — |
| EPON Resin 1163 | — | 43.15 | 29.26 | 28.00 | 28.01 |
| Epoxidized DCPD | — | — | — | 20.97 | 20.48 |
| Phenol Novolac-B-75 | | | | | |
| Epoxidized DCPD | — | — | 29.46 | — | — |
| phenolic resin | | | | | |
| Phenolic Novolac | — | 39.47 | — | — | — |
| Octylphenol Novolac-B-65 | — | — | 63.31 | 33.00 | 32.60 |
| PPO-B-50 | — | — | — | 64.11 | 64.08 |
| 25 wt % Oligomeric | — | — | — | — | 3.00 |
| Butadiene | | | | | |
| Homopolymer/75 wt % | | | | | |
| Toluene | | | | | |
| MEK | — | — | 1.46 | — | — |
| Acetone | — | 29.21 | 17.32 | — | — |
| PGME | — | 17.11 | 7.50 | 12.59 | 12.21 |
| 7% DICY/93% MeOX | 100.53 | — | — | — | — |
| 10% 2MI/90% MeOX | 2.70 | — | — | — | — |
| 10% 2MI/90% PGME | — | 0.71 | 6.01 | 4.25 | 3.44 |
| Varnish Gel Time | 117 | 191 | 204 | 195 | 197 |
| (seconds) | | | | | |
| Prepreg Oven Time | 2.75 | 3.00 | 5.00 | 4.50 | 5.00 |
| (minutes) | | | | | |
| Prepreg Appearance | Excellent | Excellent | Very | Very | Good |
| | | | Poor | Poor | |
| T_{g} (DSC, ° C., 2^{nd} heat)* | 137 | 157 | 176 | 170 | 173 |
| T_{d} (TGA, ° C., 5% wt loss)* | 295 | 337 | 329 | 331 | 332 |
| Electrical Properties** | | | | | |
| Dₖ @ 1 GHz | 3.17 | 3.24 | 2.84 | 2.92 | 2.89 |
| D_{f} @ 1 GHz | 0.0237 | 0.0289 | 0.0090 | 0.0140 | 0.0078 |

*Laminate properties;
**Neat Casting Properties
In Table 3, “A” denotes acetone, “B” denotes MEK with the number afterwards denoting the wt % of the solid.

### Example 12

### Conventional Novolac Cured Laminating Resin for Lead-Free Based Soldering Applications with Superior Electrical Performance and Enhanced Prepreg Appearance Using a Type I Alkylphenol Novolac, a Standard Molecular Weight PPO (at a Concentration Similar to Comparative Example 5) and an Oligomeric Butadiene Homopolymer

This example provides: an electrical laminating resin formulation used for lead-free PCB solder applications with superior electrical performance and enhanced prepreg appearance; its prepregging characteristics; and its neat resin and laminate properties.

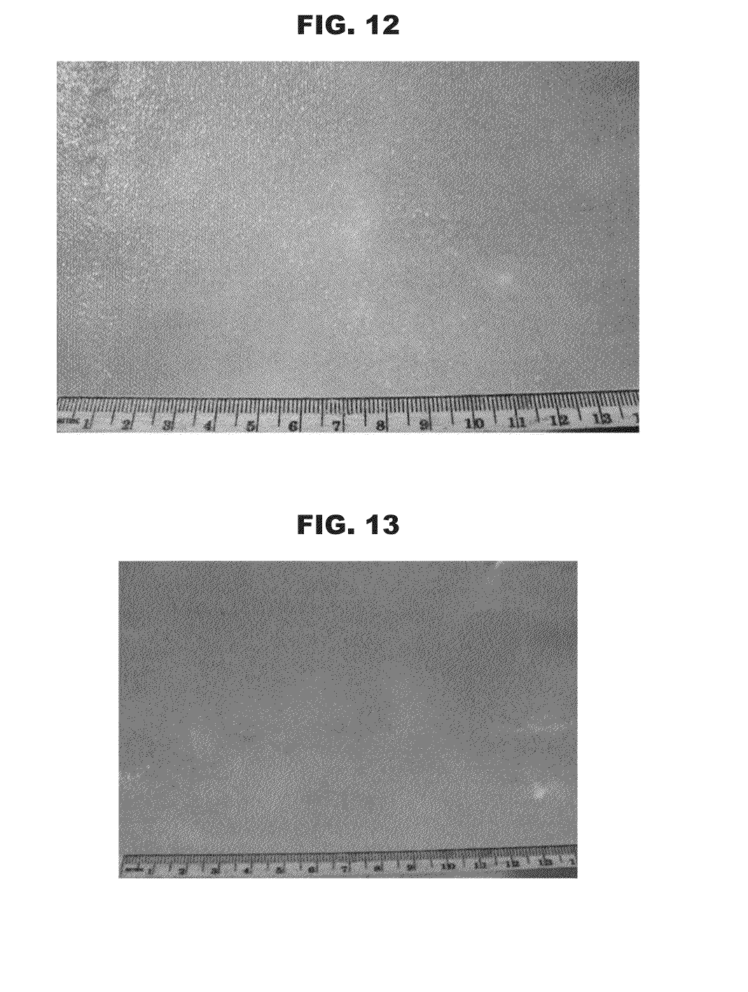

The varnish composition of Example 12 was prepared from its components according to Table 4 and the procedures described in Comparative Example 1. Its composition is very similar to Comparative Example 5 except it also contains an oligomeric butadiene homopolymer to provide enhanced prepreg surface appearance. Its varnish was prepared using an epoxidized DCPD phenol resin (having a WPE of 285), EPON Resin 1031 and EPON Resin 1163. To this resin mixture was added an Octylphenol novolac (with a Weight Average Molecular Weight, M_{w} of 1715 and residual monomer content of less than 1.0 weight percent. This Octylphenol novolac was allowed to completely dissolve, at ambient temperature with mechanical agitation, into the resin solution. A solution of 50 weight percent poly(2,6-dimethyl-1,4-phenylene oxide, PPO) with a M_{w} of 3605 and a Polydispersity Index (PDᵢ) of 1.96 dissolved in MEK was then added with stirring into the previously made resin solution. The PPO was made without using a redistribution or rearrangement reaction and it did not contain any metal salt compatibilizers. A solution containing 25 wt % oligomeric butadiene homopolymer dissolved in 75 wt % Toluene was added to the resin solution with stirring. The oligomeric butadiene homopolymer had a M_{w} value of 8490 and a molar 1,2-vinyl content of 85 wt %. A solution of 10 weight percent 2MI and 90 weight percent PGME was then added into the resin solution with stirring. The gel time of this reactive varnish was 209 seconds. Each sheet of prepreg was kept in the air-circulating oven for 4.25 minutes. After allowing the prepreg to cool to room temperature, the surface appearance of this laboratory prepared prepreg was judged to be excellent. It was transparent, shiny and it contained a very few small craters and blister defects with minimum resin sags. FIG. 12 provides a representative photograph of this prepreg. A comparison of this Figure with FIG. 5 illustrates the improvement in prepreg appearance with the addition of the oligomeric butadiene homopolymer. Eight ply laminates were made as described in Comparative Example 1 and their properties are reported in Table 4.

TABLE 4

| | Resin Characteristics | | | | |
|---|---|---|---|---|---|
| | | | | | Lead Free, Superior |
| | | | Lead Free, Improved | Lead Free, Superior | Electricals, Type I |
| | | | Electricals, Type I | Electricals, Type I | Novolac, Enhanced |
| | Lead Based | Lead Free | Novolac | Novolac | Appearance |
| | Parts (grams) | | | | |
| | Comparative Example Number | | | | Example |
| Component | 1 | 2 | 3 | 5 | 12 |
| EPON Resin 1124-A-80 | 303.70 | — | — | — | — |
| EPON Resin 1031 | — | 14.32 | 3.38 | 3.03 | 3.14 |
| EPON Resin 154-A-80 | — | 53.96 | — | — | — |
| EPON Resin 1163 | — | 43.15 | 29.26 | 28.09 | 27.99 |
| Epoxidized DCPD | — | — | 29.46 | 18.31 | 17.84 |
| Phenol Novolac | | | | | |
| Phenolic Novolac | — | 39.47 | — | — | — |
| Octylphenol Novolac-B-65 | — | — | 63.31 | 39.05 | 38.77 |
| PPO-B-50 | — | — | — | 50.76 | 50.42 |
| 25 wt % Oligomeric | — | — | — | — | 3.14 |
| Butadiene | | | | | |
| Homopolymer/75 wt % | | | | | |
| Toluene | | | | | |
| MEK | — | — | 1.46 | — | — |
| Acetone | — | 29.21 | 17.32 | — | — |
| PGME | — | 17.11 | 7.50 | 8.03 | 25.90 |
| 7% DICY/93% MeOX | 100.53 | — | — | — | — |
| 10% 2MI/90% MeOX | 2.70 | — | — | — | — |
| 10% 2MI/90% PGME | — | 0.71 | 6.01 | 4.07 | 4.50 |
| Varnish Gel Time | 117 | 191 | 204 | 240 | 209 |
| (seconds) | | | | | |
| Prepreg Oven Time | 2.75 | 3.00 | 5.00 | 4.00 | 4.25 |
| (minutes) | | | | | |
| Prepreg Appearance | Excellent | Excellent | Very | Very | Excellent |
| | | | Poor | Poor | |
| T_{g} (DSC, ° C., 2^{nd} heat)* | 137 | 157 | 176 | 176 | 171 |
| T_{d} (TGA, ° C., 5% wt loss)* | 295 | 337 | 329 | 331 | 329 |

*Laminate properties
In Table 4, “A” denotes acetone, “B” denotes MEK with the number afterwards denoting the wt % of the solid.

### Example 13

### Conventional Novolac Cured Laminating Resin for Lead-Free Based Soldering Applications with Superior Electrical Performance Composed of Type I Alkylphenol Novolac, a Lower Molecular Weight PPO (at a Concentration Similar to Comparative Example 8) and an Oligomeric Butadiene Homopolymer

This example provides: an electrical laminating resin formulation used for lead-free PCB solder applications with superior electrical performance; its prepregging characteristics; and its neat resin and laminate properties.

The varnish composition of Example 13 was prepared from its components according to Table 5 and the procedures described in Comparative Example 1. Its composition is very similar to Comparative Example 8 except it contained an oligomeric butadiene homopolymer. Its varnish was prepared using an epoxidized DCPD phenol resin (having a WPE of 285), EPON Resin 1031 and EPON Resin 1163. To this resin mixture was added an Octylphenol novolac (with a Weight Average Molecular Weight, M, of 1715 and residual monomer content of less than 1.0 weight percent. This Octylphenol novolac was allowed to completely dissolve, at ambient temperature with mechanical agitation, into the resin solution. A solution of 50 weight percent poly(2,6-dimethyl-1,4-phenylene oxide, PPO) with a M_{w}, of 2573 and a Polydispersity Index (PDᵢ) of 1.86 dissolved in MEK was then added with stirring into the previously made resin solution. The PPO was made without using a redistribution or rearrangement reaction and it did not contain any metal salt compatibilizers. A solution containing 25 wt % oligomeric butadiene homopolymer dissolved in 75 wt % Toluene was added to the resin solution with stirring. The oligomeric butadiene homopolymer had a M_{w} value of 8490 and a molar 1,2-vinyl content of 85 wt %. A solution of 10 weight percent 2MI and 90 weight percent PGME was then added into the resin solution with stirring. The gel time of this reactive varnish was 219 seconds. Each sheet of prepreg was kept in the air-circulating oven for 4.25 minutes. After allowing the prepreg to cool to room temperature, the surface appearance of this laboratory prepared prepreg was judged to be excellent. It was transparent, shiny and it contained a very few small craters and blister defects with minimum resin sags. After allowing the prepreg to cool to room temperature, the surface appearance of this laboratory prepared prepreg was judged to be excellent. It was transparent, shiny and it contained a very few small craters and blister defects with minimum resin sags. FIG. 13 provides a representative photograph of this prepreg. A comparison of this Figure with FIG. 8 illustrates the improvement in prepreg appearance with the addition of the oligomeric butadiene homopolymer. Eight ply laminates were made as described in Comparative Example 1 and their properties are reported in Table 5.

TABLE 5

| | Resin Characteristics | | | | |
|---|---|---|---|---|---|
| | | | | | Lead Free, Superior |
| | | | Lead Free, Improved | Lead Free, Superior | Electricals, Type I |
| | | | Electricals, Type I | Electricals, Type I | Novolac, Enhanced |
| | Lead Based | Lead Free | Novolac | Novolac | Appearance |
| | Parts (grams) | | | | |
| | Comparative Example Number | | | | Example |
| Component | 1 | 2 | 3 | 8 | 13 |
| EPON Resin 1.124-A-80 | 303.70 | — | — | — | — |
| EPON Resin 1031 | — | 14.32 | 3.38 | 2.98 | 2.95 |
| EPON Resin 154-A-80 | — | 53.96 | — | — | — |
| EPON Resin 1163 | — | 43.15 | 29.26 | 27.97 | 27.76 |
| Epoxidized DCPD Phenol | — | — | 29.46 | 18.98 | 18.84 |
| Novolac | | | | | |
| Phenolic Novolac | — | 39.47 | — | — | — |
| Octylphenol Novolac-B-65 | — | — | 63.31 | 38.49 | 38.18 |
| PPO-B-50 | — | — | — | 50.03 | 49.66 |
| 25 wt % Oligomeric | — | — | — | — | 3.02 |
| Butadiene | | | | | |
| Homopolymer/75 wt % | | | | | |
| Toluene | | | | | |
| MEK | — | — | 1.46 | — | — |
| Acetone | — | 29.21 | 17.32 | — | — |
| PGME | — | 17.11 | 7.50 | 28.22 | 26.30 |
| 7% DICY/93% MeOX | 100.53 | — | — | — | — |
| 10% 2MI/90% MeOX | 2.70 | — | — | — | — |
| 10% 2MI/90% PGME | — | 0.71 | 6.01 | 4.49 | 4.51 |
| Varnish Gel Time | 117 | 191 | 204 | 231 | 219 |
| (seconds) | | | | | |
| Prepreg Oven Time | 2.75 | 3.00 | 5.00 | 4.25 | 4.25 |
| (minutes) | | | | | |
| Prepreg Appearance | Excellent | Excellent | Very | Poor | Excellent |
| | | | Poor | | |
| T_{g} (DSC, ° C., 2^{nd} heat)* | 137 | 157 | 176 | 168 | 165 |
| T_{d} (TGA, ° C., 5% wt loss)* | 295 | 337 | 329 | 329 | 327 |

*Laminate properties
In Table 5, “A” denotes acetone, “B” denotes MEK with the number afterwards denoting the wt % of the solid.

### Example 14

### Conventional Novolac Cured Laminating Resin for Lead-Free Based Soldering Applications with Superior Electrical Performance Composed of a Type II Alkylphenol Novolac, a Higher Concentration (Similar to Comparative Example 9) of the Standard Molecular Weight PPO and an Oligomeric Butadiene Homopolymer

This example provides: an electrical laminating resin formulation used for lead-free PCB solder applications with superior electrical performance and enhanced prepreg appearance; its prepregging characteristics; and its neat resin and laminate properties. It is presented as a basis for comparison with the proposed formulation improvements provided in this patent.

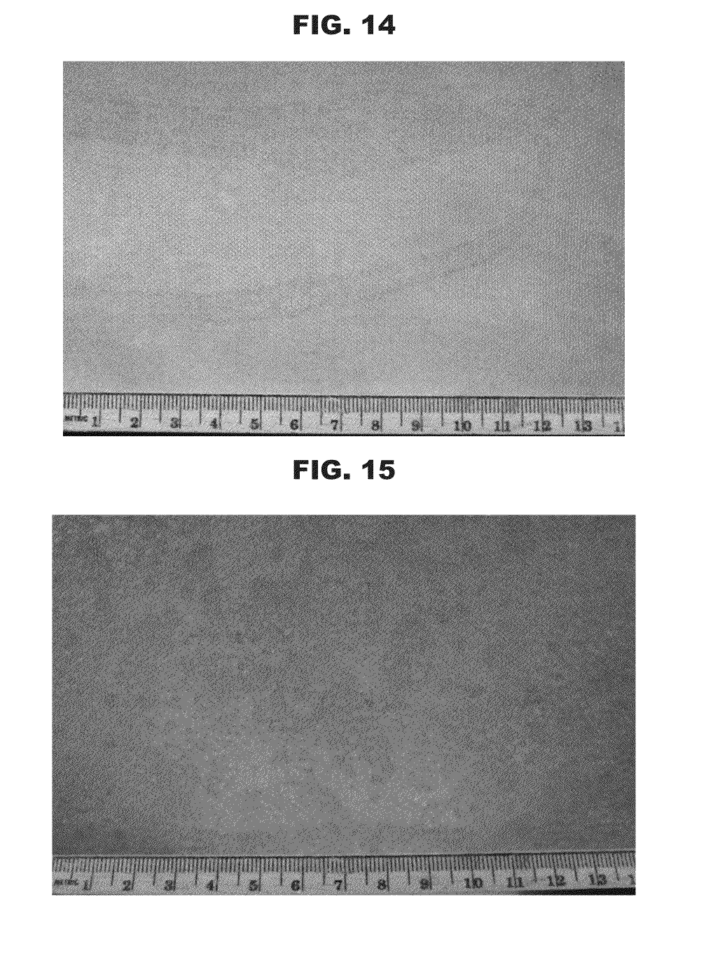

The varnish composition of Example 14 was prepared from its components according to Table 6 and the procedures described in Comparative Example 1. Its composition was very similar with Comparative Example 9 except it contains an oligomeric butadiene homopolymer to provide enhanced surface appearance. Its varnish was prepared using an epoxidized DCPD phenol resin solution (having a WPE of 285) that was 75 wt % epoxidized DCPD phenolic resin and 25 wt % MEK, EPON Resin 1031, and EPON Resin 1163. To this resin mixture was added a co-novolac composed of Octylphenol and tert-Butylphenol with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 50 weight percent poly(2,6-dimethyl-1,4-phenylene oxide, PPO) with a M_{w} of 3605 and a Polydispersity Index (PDᵢ) of 1.96 dissolved in MEK was then added with stirring into the previously made resin solution. The PPO was made without using a redistribution or rearrangement reaction and it did not contain any metal salt compatibilizers. A solution containing 25 wt % oligomeric butadiene homopolymer dissolved in 75 wt % toluene was added to the resin solution with stirring. The oligomeric butadiene homopolymer had a M_{w} value of 8490 and a molar 1,2-vinyl content of 85 wt %. A solution of 10 weight percent 2MI and 90 weight percent PGME was then added into the resin solution with stirring. The gel time of this reactive varnish was 199 seconds. Each sheet of prepreg was kept in the air-circulating oven for 4.75 minutes. After allowing the prepreg to cool to room temperature, the surface appearance of this laboratory prepared prepreg was judged to be excellent. It was transparent, shiny and it contained a very few small craters and blister defects with minimum resin sags. Eight ply laminates were also made as described in Comparative Example 1 and their properties are reported in Table 6. FIG. 14 provides a representative photograph of this prepreg. A comparison of this Figure with FIG. 9 illustrates the improvement in prepreg appearance with the addition of the oligomeric butadiene homopolymer. A neat resin casting was made as described in Comparative Example 1; and, its electrical properties are reported in Table 6 and FIG. 3 and FIG. 4. Eight ply laminates were made as described in Comparative Example 1 and their properties are also reported in Table 6.

TABLE 6

| | Resin Characteristics | | | | |
|---|---|---|---|---|---|
| | | | | | Lead Free, Superior |
| | | | Lead Free, Improved | Lead Free, Superior | Electricals, Type II |
| | | | Electricals, Type II | Electricals, Type II | Novolac, Enhanced |
| | Lead Based | Lead Free | Novolac | Novolac | Appearance |
| | Parts (grams) | | | | |
| | Comparative Example Number | | | | Example |
| Component | 1 | 2 | 4 | 9 | 14 |
| EPON Resin 1124-A-80 | 303.70 | — | — | — | — |
| EPON Resin 1031 | — | 14.32 | 2.98 | 3.00 | 3.00 |
| EPON Resin 154-A-80 | — | 53.96 | — | — | — |
| EPON Resin 1163 | — | 43.15 | 27.79 | 28.01 | 28.02 |
| Epoxidized DCPD | — | — | — | 24.83 | 24.39 |
| Phenol Novolac-B-75 | | | | | |
| Epoxidized DCPD | — | — | 32.40 | — | — |
| Phenol Novolac | | | | | |
| Phenolic Novolac | — | 39.47 | — | — | — |
| Octylphenol/tert- | — | — | 36.08 | — | — |
| butylphenol Co-novolac | | | | | |
| Octylphenol/tert- | — | — | — | 30.99 | 30.75 |
| butylphenol | | | | | |
| Co-novolac-B-65 | | | | | |
| PPO-B-50 | — | — | — | 60.51 | 59.96 |
| 25 wt % Oligomeric | — | — | — | — | 2.99 |
| Butadiene | | | | | |
| Homopolymer/75 wt % | | | | | |
| Toluene | | | | | |
| MEK | — | — | 11.17 | — | — |
| Acetone | — | 29.21 | 30.61 | — | — |
| PGME | — | 17.11 | 7.47 | 14.13 | 14.09 |
| 7% DICY/93% MeOX | 100.53 | — | — | — | — |
| 10% 2MI/90% MeOX | 2.70 | — | — | — | — |
| 10% 2MI/90% PGME | — | 0.71 | 4.78 | 3.50 | 3.50 |
| Varnish Gel Time | 117 | 191 | 196 | 195 | 199 |
| (seconds) | | | | | |
| Prepreg Oven Time | 2.75 | 3.00 | 5.00 | 4.50 | 4.75 |
| (minutes) | | | | | |
| Prepreg Appearance | Excellent | Excellent | Very | Very | Good |
| | | | Poor | Poor | |
| T_{g} (DSC, ° C., 2^{nd} heat)* | 137 | 157 | 176 | 180 | 178 |
| T_{d} (TGA, ° C., 5% wt loss)* | 295 | 337 | 329 | 324 | 337 |
| Electrical Properties** | | | | | |
| Dₖ @ 1 GHz | 3.17 | 3.24 | 2.85 | 2.90 | 2.94 |
| D_{f} @ 1 GHz | 0.0237 | 0.0289 | 0.0140 | 0.0175 | 0.0140 |

*Laminate properties;
**Neat Casting Properties
In Table 6, “A” denotes acetone, “B” denotes MEK with the number afterwards denoting the wt % of the solid.

### Example 15

### Conventional Novolac Cured Laminating Resin for Lead-Free Based Soldering Applications with Superior Electrical Performance and Enhanced Prepreg Appearance Composed of a Type II Alkylphenol Novolac, a Standard Molecular Weight PPO (at a Concentration Similar to Comparative Example 6) and an Oligomeric Butadiene Homopolymer

This example provides: an electrical laminating resin formulation used for lead-free PCB solder applications with superior electrical performance and enhanced prepreg appearance; its prepregging characteristics; and its neat resin and laminate properties.

The varnish composition of Example 15 was prepared from its components according to Table 7 and the procedures described in Comparative Example 1. Its composition is very similar to Comparative Example 6 except it also contained an oligomeric butadiene homopolymer to provide enhanced prepreg appearance. Its varnish was prepared using an epoxidized DCPD phenol resin solution (having a WPE of 285) that was 75 wt % epoxidized DCPD phenolic resin and 25 wt % MEK, EPON Resin 1031, and EPON Resin 1163. To this resin mixture was added an Octylphenol/tert-Butylphenol co-novolac (with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 50 weight percent poly(2,6-dimethyl-1,4-phenylene oxide, PPO) with a M_{w} of 3605 and a Polydispersity Index (PDᵢ) of 1.96 dissolved in MEK was then added with stirring into the previously made resin solution. The PPO was made without using a redistribution or rearrangement reaction and it did not contain any metal salt compatibilizers. A solution containing 25 wt % oligomeric butadiene homopolymer dissolved in 75 wt % toluene was added to the resin solution with stirring. The oligomeric butadiene homopolymer had a M_{w} value of 8490 and a molar 1,2-vinyl content of 85 wt %. A solution of 10 weight percent 2MI and 90 weight percent PGME was then added into the resin solution with stirring. The gel time of this reactive varnish was 198 seconds. Each sheet of prepreg was kept in the air-circulating oven for 4.25 minutes. After allowing the prepreg to cool to room temperature, the surface appearance of this laboratory prepared prepreg was judged to be excellent. It was transparent, shiny and it contained a very few small craters and blister defects with minimum resin sags. FIG. 15 provides a representative photograph of this prepreg. A comparison of this Figure with FIG. 6 illustrates the improvement in prepreg appearance with the addition of the oligomeric butadiene homopolymer. Eight ply laminates were made as described in Comparative Example 1 and their properties are reported in Table 7.

TABLE 7

| | Resin Characteristics | | | | |
|---|---|---|---|---|---|
| | | | | | Lead Free, Superior |
| | | | Lead Free, Improved | Lead Free, Superior | Electricals, Type II |
| | | | Electricals, Type II | Electricals, Type II | Novolac, Enhanced |
| | Lead Based | Lead Free | Novolac | Novolac | Appearance |
| | Parts (grams) | | | | |
| | Comparative Example Number | | | | Example |
| Component | 1 | 2 | 4 | 6 | 15 |
| EPON Resin 1124-A-80 | 303.70 | — | — | — | — |
| EPON Resin 1031 | — | 14.32 | 2.98 | 2.98 | 3.02 |
| EPON Resin 154-A-80 | — | 53.96 | — | — | — |
| EPON Resin 1163 | — | 43.15 | 27.79 | 27.97 | 28.01 |
| Epoxidized DCPD Phenol | — | — | 32.40 | 21.75 | — |
| Novolac | | | | | |
| Epoxidized DCPD Phenol | — | — | — | — | 28.55 |
| Novolac-B-75 | | | | | |
| Phenolic Novolac | — | 39.47 | — | — | — |
| Octylphenol/tert- | — | — | — | 36.41 | 36.09 |
| butylphenol | | | | | |
| Co-novolac-B-65 | | | | | |
| PPO-B-50 | — | — | 36.08 | 47.24 | 46.87 |
| 25 wt % Oligomeric | — | — | — | — | 2.99 |
| Butadiene | | | | | |
| Homopolymer/75 wt % | | | | | |
| Toluene | | | | | |
| MEK | — | — | 11.17 | 9.65 | 0.59 |
| Acetone | — | 29.21 | 30.61 | — | — |
| PGME | — | 17.11 | 7.47 | 15.49 | 15.42 |
| 7% DICY/93% MeOX | 100.53 | — | — | — | — |
| 10% 2MI/90% MeOX | 2.70 | — | — | — | — |
| 10% 2MI/90% PGME | — | 0.71 | 4.78 | 4.04 | 4.25 |
| Varnish Gel Time | 117 | 191 | 196 | 226 | 198 |
| (seconds) | | | | | |
| Prepreg Oven Time | 2.75 | 3.75 | 5.00 | 4.50 | 4.25 |
| (minutes) | | | | | |
| Prepreg Appearance | Excellent | Excellent | Very | Very | Excellent |
| | | | Poor | Poor | |
| T_{g} (DSC, ° C., 2^{nd} heat)* | 137 | 157 | 176 | 179 | 174 |
| T_{d} (TGA, ° C., 5% wt loss)* | 295 | 337 | 331 | 331 | 331 |

*Laminate properties
In Table 7, “A” denotes acetone, “B” denotes MEK with the number afterwards denoting the wt % of the solid.

### Example 16

### Conventional Novolac Cured Laminating Resin for Lead-Free Based Soldering Applications with Superior Electrical Performance Composed of a Type II Alkylphenol Novolac, a Lower Molecular Weight PPO (at a Concentration Similar to Comparative Example 10) and an Oligomeric Butadiene Homopolymer

This example provides: an electrical laminating resin formulation used for lead-free PCB solder applications with superior electrical performance and enhanced prepreg appearance; its prepregging characteristics; and its neat resin and laminate properties.

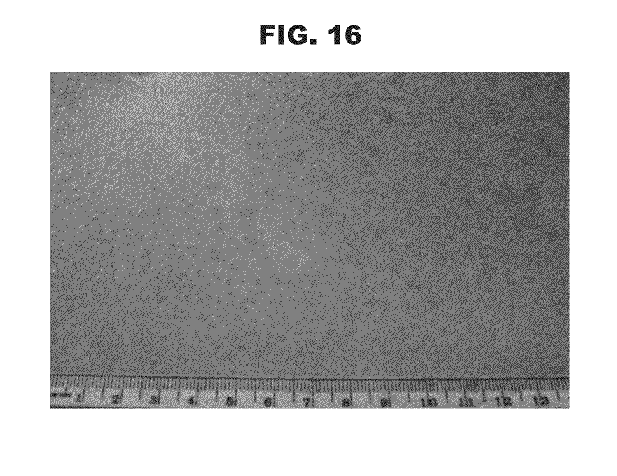

The varnish composition of Example 16 was prepared from its components according to Table 8 and the procedures described in Comparative Example 1. Its composition was very similar with Comparative Example 10 except it contained an oligomeric butadiene homopolymer to provide enhanced prepreg surface appearance. Its varnish was prepared using an epoxidized DCPD phenol resin (having a WPE of 285), EPON Resin 1031 and EPON Resin 1163. To this resin mixture was added a co-novolac composed of Octylphenol and tert-Butylphenol with a Weight Average Molecular Weight, M_{w} of 1442 and residual monomer content of less than 1.0 weight percent. This co-novolac was allowed to completely dissolve, at ambient temperature with mechanical agitation, into the resin solution. A solution of 50 weight percent poly(2,6-dimethyl-1,4-phenylene oxide, PPO) with a M_{w} of 2573 and a Polydispersity Index (PDᵢ) of 1.86 dissolved in MEK was then added with stirring into the previously made resin solution. The PPO was made without using a redistribution or rearrangement reaction and it did not contain any metal salt compatibilizers. A solution containing 25 wt % oligomeric butadiene homopolymer dissolved in 75 wt % toluene was added to the resin solution with stirring. The oligomeric butadiene homopolymer had a M_{w} value of 8490 and a molar 1,2-vinyl content of 85 wt %. A solution of 10 weight percent 2MI and 90 weight percent PGME was then added into the resin solution with stirring. The gel time of this reactive varnish was 205 seconds. Each sheet of prepreg was kept in the air-circulating oven for 4.50 minutes. After allowing the prepreg to cool to room temperature, the surface appearance of this laboratory prepared prepreg was judged to be excellent. It was transparent, shiny and it contained a very few small craters and blister defects with minimum resin sags. FIG. 16 provides a representative photograph of this prepreg. A comparison of this Figure with FIG. 10 illustrates the improvement in prepreg appearance with the addition of the oligomeric butadiene homopolymer. Eight ply laminates were made as described in Comparative Example 1 and their properties are reported in Table 8.

TABLE 8

| | Resin Characteristics | | | | |
|---|---|---|---|---|---|
| | | | | | Lead Free, Superior |
| | | | Lead Free, Improved | Lead Free, Superior | Electricals, Type II |
| | | | Electricals, Type II | Electricals, Type II | Novolac, Enhanced |
| | Lead Based | Lead Free | Novolac | Novolac | Appearance |
| | Parts (grams) | | | | |
| | Comparative Example Number | | | | Example |
| Component | 1 | 2 | 4 | 10 | 16 |
| EPON Resin 1124-A-80 | 303.70 | — | — | — | — |
| EPON Resin 1031 | — | 14.32 | 2.98 | 3.00 | 2.99 |
| EPON Resin 154-A-80 | — | 53.96 | — | — | — |
| EPON Resin 1163 | — | 43.15 | 27.79 | 28.02 | 27.99 |
| Epoxidized DCPD | — | — | 32.40 | 22.42 | 22.05 |
| Phenol Novolac | | | | | |
| Phenolic Novolac | — | 39.47 | — | — | — |
| Octylphenol/tert- | — | — | 36.08 | — | — |
| butylphenol Co-novolac | | | | | |
| Octylphenol/tert- | — | — | — | 35.83 | 35.53 |
| butylphenol | | | | | |
| Co-novolac-B-65 | | | | | |
| PPO-B-50 | — | — | — | 46.62 | 46.22 |
| 25 wt % Oligomeric | — | — | — | — | 3.01 |
| Butadiene | | | | | |
| Homopolymer/75 wt % | | | | | |
| Toluene | | | | | |
| MEK | — | — | 11.17 | 15.34 | 10.50 |
| Acetone | — | 29.21 | 30.61 | — | — |
| PGME | — | 17.11 | 7.47 | 10.56 | 14.81 |
| 7% DICY/93% MeOX | 100.53 | — | — | — | — |
| 10% 2MI/90% MeOX | 2.70 | — | — | — | — |
| 10% 2MI/90% PGME | — | 0.71 | 4.78 | 5.01 | 5.00 |
| Varnish Gel Time | 117 | 191 | 196 | 208 | 205 |
| (seconds) | | | | | |
| Prepreg Oven Time | 2.75 | 3.00 | 5.00 | 4.50 | 4.50 |
| (minutes) | | | | | |
| Prepreg Appearance | Excellent | Excellent | Very Poor | Marginally | Excellent |
| | | | | Acceptable/Poor | |
| T_{g} (DSC, ° C., 2^{nd} heat)* | 137 | 157 | 176 | 176 | 175 |
| T_{d} (TGA, ° C., 5% wt loss)* | 295 | 337 | 331 | 323 | 323 |

*Laminate properties
In Table 8, “A” denotes acetone, “B” denotes MEK with the number afterwards denoting the wt % of the solid.

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

1. A thermosetting epoxy resin composition comprising:
(1) an epoxy resin component;
(2) an epoxidized cycloaliphatic dicyclopentadiene phenolic resin;
(3) a liquid oligomeric butadiene homopolymer; and
(4) a curing agent comprising:
(A) one or more alkylphenol novolac resins or alkylphenol resin co-novolacs; and
(B) one or more poly(2,6-dimethyl-1,4-phenylene oxides).

2. The composition of claim 1 wherein:
(1) the epoxy resin is present from about 25 wt % to about 75 wt %;
(2) the epoxidized cycloaliphatic dicyclopentadiene phenolic resin is present from about 5 wt % to about weight 50 wt %; and
(3) the liquid oligomeric butadiene homopolymer is present from about 0.05 wt % to about 4 wt %;
wherein the wt % is based upon the weight of all the components in the composition.

3. The composition of claim 1 wherein:
(A) the one or more alkylphenol novolac resins or alkylphenol resin co-novolacs is present, in a weight ratio of total epoxy groups of the epoxy resin component to total phenolic hydroxyl equivalents of the alkylphenol novolac resins or alkylphenol resin co-novolacs, of between about 0.5 to about 1.5.

4. The composition of claim 1 wherein:
(B) the one or more poly(2,6-dimethyl-1,4-phenylene oxides) is present, in a weight ratio to the epoxidized cycloaliphatic dicyclopentadiene phenolic resin, of between about 0.7:1 to about 1.3:1.

5. The composite of claim 1 wherein the epoxidized cycloaliphatic dicyclopentadiene phenolic resin is produced from an epihalohydrin and a dicyclopentadiene polyphenolic compound having the general formula: 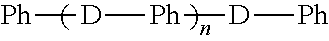
where:
n is a whole number from 0 to 7;
Ph is a phenylol radical derived from mononuclear phenol;
and D is a tricyclodecylene radical having a general formula:

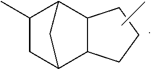

6. The composition of claim 1 wherein the liquid oligomeric butadiene homopolymer has a molar 1,2-vinyl molar group content from about 5 to about 95%.

7. The composition of claim 1 wherein the liquid oligomeric butadiene homopolymer has a weight average molecular weight of between about 1000 to about 20000 Daltons.

8. The composition of claim 1 wherein the liquid oligomeric butadiene homopolymer comprises a molar 1,2-vinyl group content of from about 25% to about 99%.

9. The composition of claim 1 wherein the curing agent comprises an alkylphenol novolac resin having the general formula of: 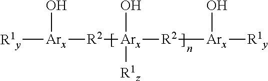
where:
Ar represents an aryl or alkyl-aryl group;
each Ar group contains x number of non-aromatic carbon atoms;
OH represents a hydroxyl group bonded to each Ar group;
each R¹ represents substituent group(s) bonded to each Ar group;
each R² represents a group connecting adjacent Ar groups;
n is a number between 2 and 20;
x is an integer from 4 to 8;
y is an integer from 1 to x−2; and
z is an integer from 1 to x−3.

10. The composition of claim 1 where the curing agent comprises an alkylphenol novolac resin having the general formula: 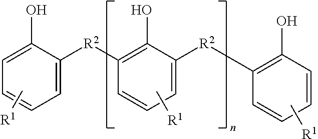
where:
R¹ may be the same or different and is an alkyl group or aryl group containing 2 to 20 carbon atoms; and
R² may be the same or different and is an alkyl group containing 1 to 5 carbon atoms.

11. The composition of claim 1 wherein the one or more alkylphenol novolac resins or alkylphenol resin co-novolacs is selected from octyl phenol novolac, octyl phenol t-butyl phenol co-novalac, or a combination thereof.

12. The composition of claim 1 wherein the one or more alkylphenol novolac resins or alkylphenol resin co-novolacs comprises octyl phenol novolac and butyl novolac.

13. The composition of claim 1 wherein the epoxy resin component comprises an epoxidized multifunctional resin having a WPE of about 200 to about 240, and a diglycidyl ether from epichlorohydrin and tetrabromobisphenol of acetone having a WPE from 380 to 410.

14. The composition of claim 1 wherein the composition further comprises a solvent.

15. A prepreg prepared using the thermosetting epoxy resin composition of claim 1.

16. A laminate prepared using the prepreg of claim 15.

17. A composite prepared using the thermosetting epoxy resin composition of claim 1.
